(19) United States
(12) Patent Application Publication
(10) Pub. No.: US 2015/0321419 A1
(43) Pub. Date: Nov. 12, 2015

(54) EXTRUSION SYSTEM FOR ADDITIVE MANUFACTURING AND 3-D PRINTING

(71) Applicants: Todd Linthicum, Pickerington, OH (US); David Slade Simpson, Dublin, OH (US); Bryan Linthicum, Pickerington, OH (US); Phillip Peterson, Philadelphia, PA (US)

(72) Inventors: Todd Linthicum, Pickerington, OH (US); David Slade Simpson, Dublin, OH (US); Bryan Linthicum, Pickerington, OH (US); Phillip Peterson, Philadelphia, PA (US)

(21) Appl. No.: 14/705,940

(22) Filed: May 6, 2015

Related U.S. Application Data
(60) Provisional application No. 61/989,179, filed on May 6, 2014.
(60) Provisional application No. 62/119,260, filed on Feb. 22, 2015.

(51) Int. Cl. B29C 67/00; B29C 47/60; B29C 47/66; B29C 47/38

(52) U.S. Cl. CPC B29C 67/0055; B29C 47/38; B29C 47/6093; B29C 47/661; B29K 2101/12

(57) ABSTRACT

The invention, and all of its embodiments, is a 3-D printer that utilizes one or more extrusion screws to process any given material including, but not limited to, plastic, metal, composites and non-metals to build 3-dimensional objects. The processed material is deposited on a moveable platform via force from the extrusion process. Motion is numerically controlled via a computer and one or more motors. As the extruder deposits material, a platform or the extruder is moved in one, two, or three dimensions at a predetermined vector. Once a layer of the object is created, the distance between the extruder nozzle and print surface is increased and the process is repeated until a three dimensional shape is created.

This application is based upon and claims the priority filing date of the previously filed, copending U.S. Provisional patent application entitled “EXTRUSION SYSTEM FOR ADDITIVE MANUFACTURING AND 3-D PRINTING AND METHOD OF SYNCHRONIZED CONTROL OF INDEPENDENT MOTOR AXES” filed May 6, 2014, Ser. No. 61/989,179, the entire disclosure of which is hereby incorporated herein by reference and U.S. Provisional patent application entitled “EXTRUSION SYSTEM FOR ADDITIVE MANUFACTURING AND 3-D PRINTING” filed Feb. 22, 2015, Ser. No. 62/119,260, the entire disclosure of which is hereby incorporated herein by reference.

### BACKGROUND

The present invention pertains to additive manufacturing, specifically the field of compact 3D printing.

3-D printing or additive manufacturing is any of various processes used to make a three-dimensional object. In 3-D printing, additive processes are used, in which successive layers of material are laid down under computer control. These objects can be of almost any shape or geometry, and are produced from a 3-D model or other electronic data source. A 3-D printer is a type of industrial robot.

There are a large number of additive processes now available. The main differences between processes are in the way layers are deposited to create parts and in the materials that are used. Some methods melt or soften material to produce the layers, e.g. selective laser melting (SLM) or direct metal laser sintering (DMLS), selective laser sintering (SLS), fused deposition modeling (FDM), or fused filament fabrication (FFF), while others cure liquid materials using different sophisticated technologies, e.g. stereolithography (SLA). With laminated object manufacturing (LOM), thin layers are cut to shape and joined together (e.g. paper, polymer, metal). Each method has its own advantages and drawbacks. The main considerations in choosing a machine are generally speed, cost of the 3-D printer, cost of the printed prototype, cost and choice of materials, and color capabilities.

More recently, 3-D printers have been developed in a more compact configuration at affordable costs. Currently, most compact type 3-D printers, particularly desktop 3-D printers utilize the additive method using plastic filament strands (or liquid-phase resin), which are fed into a heated nozzle via geared motor or other actuation system. Along with this, a platform moves beneath the nozzle to form 2-D shapes at a given height. When a shape is complete, the bed and nozzle are moved further apart, and the 2-D shapes are stacked, resulting in a 3-D object. This process is traditionally controlled numerically, via a computer/processor.

Currently in the art, 3D printers have not been developed to directly and continuously utilize plastic extrusion technology. General plastic extrusion technology was conceptualized and proven in the mid-1930's, and has continued to grow as the industry standard for creating plastic objects. The process commonly uses a tapered screw and a heated sleeve (often called a ‘barrel’) to melt plastic and force it through a given profile (called a die) or into a mold (in Injection Molding). The tapered screw allows plastic resin (also referred to as ‘pellets’) to travel deep into the heated sleeve, where it is melted by direct heat (via heaters), compression, and shear force friction heat.

Most industrial extrusion machines are far too large for use in 3-D printing, requiring specialized knowledge and maintenance to operate. These systems are also far too complicated and expensive for average consumer or commercial use. Therefore, there is a need for a 3D printer which combines the size, production method, and usability of a 3-D printer, with the flexibility and additional benefits of printing directly with a traditional extrusion method, including a tapered screw and barrel system, which is not currently present in any 3-D printer.

### SUMMARY

In accordance with the invention, an apparatus and process for making three-dimensional physical objects of a predetermined shape by sequentially extruding multiple layers of solidifying material on a print platform in a desired pattern is provided.

The apparatus for making three-dimensional physical objects includes a novel extrusion assembly. The extrusion assembly includes a barrel with an inner bore forming a cylinder, a screw rotatably mounted within the bore for forcing the solidifying material from the upstream end to the downstream end of the barrel, and a screw comprising a flight segment having a screw root and affixed to the screw root at least one helically threaded screw flight. The apparatus further includes a nozzle for dispensing the molten material having an outlet communicating with the downstream end of the barrel, a means for supplying the solidifying material to the upstream end of the barrel, a means for imparting rotation to the screw, a print platform disposed in close, working proximity to the extrusion assembly; and a mechanical means for moving the nozzle and the print platform relative to each other in multiple dimensions in a predetermined sequence and pattern.

In a version of the invention, the screw further comprises at least one compression zone, wherein the root within the compression zone increases in diameter moving downstream while the screw maintains a constant major diameter.

In another version, the screw flight segment further comprises a feeding zone, a compression zone, a pumping zone, the feeding zone configured to receive raw solidifying material located upstream, the compression zone located downstream of the feeding zone adapted to receive, heat, and compress the solidifying material into a molten condition, and the pumping zone is located downstream of the compression zone adapted to receive, move and distribute the molten solidifying material in a uniform manner to the nozzle for dispensing the solidifying material.

In yet another version, the screw further comprises a no-flight end segment and the barrel further comprises a narrowing compression end zone, the narrowing compression end zone operably positioned downstream of the barrel inner bore and upstream of the nozzle for dispensing the molten solidifying material, wherein the no-flight end segment of the screw is fitted with the narrowing compression end zone forming a compression channel therebetween. In a particular version of the invention, the compression channel expands in relative depth between the lateral narrowing compression end zone surface and the lateral no-flight end segment surface moving downstream.

Further in other embodiments, a means for removing heat from the upstream end of the barrel is provided in order to inhibit heat accumulation where the solidifying material is being distributed from the means for supplying the solidifying material to the upstream end of the barrel.

The invention also may include the process of utilizing the novel extrusion assembly in order to make the three-dimensional physical objects of a predetermined shape by sequentially extruding multiple layers of a solidifying material on a print platform in a desired pattern. Firstly, an extrusion assembly is provided comprising at least: (i) a barrel comprising an inner bore forming a cylinder, an upstream end, and an oppositely disposed downstream end; (ii) a screw rotatably mounted within the inner bore for forcing the solidifying material from the upstream end to the downstream end of the barrel, the screw comprising a flight segment having a screw root and affixed to the screw root at least one helically threaded screw flight; and a nozzle for dispensing the molten material having an outlet communicating with the downstream end of the barrel. Next, at least a print platform and a stepper motor or other means for imparting rotation to the screw is provided.

Secondly, the solidifying material is supplied to the screw at the upstream end of the barrel. Simultaneously, with the supplying of the solidifying material to the screw at the upstream end of the barrel, a controlled predetermined sequenced rotation of the screw is imparted by the stepper motor, thereby initiating and controlling the volumetric rate at which the plastic material flows downstream through the extrusion assembly, compressing the solid material into a molten state. Next, dispensing the plastic material from the nozzle in a controlled, precise manner at which it solidifies onto the print platform positioned in close proximity to the means for dispensing the molten material. Simultaneously with the dispensing of the material onto the print platform, mechanically generating relative movement of the print platform and the nozzle with respect to each other in a predetermined pattern to form a first layer of the plastic material on the print platform.

Next, displacing the nozzle a predetermined layer thickness distance from the first layer, dispensing a second layer of the material in a molten state onto the first layer from the dispensing outlet while simultaneously moving the base member and the nozzle relative to each other, whereby the second layer solidifies upon cooling and adheres to the first layer to form a three-dimensional object.

Finally, forming multiple layers of the material built up on top of each other in multiple passes by repeated dispensing of the material in a molten state from the nozzle outlet as the print platform and the nozzle are moved relative to each other, with the nozzle and the print platform being displaced a predetermined distance after each preceding layer is formed, and with the dispensing of each successive layer being controlled to take place after the material in the preceding layer immediately adjacent to the nozzle has solidified.

Still other benefits and advantages of the invention will become apparent to those skilled in the art to which it pertains upon a reading and understanding of the following detailed specification.

### BRIEF DESCRIPTION OF THE DRAWINGS

These and other features, aspects, and advantages of the present invention will become better understood with regard to the following description, appended claims, and accompanying drawings where:

FIG. 1 is a front assembled isometric view of a version of the present invention;

FIG. 2 is a front isometric view of the version shown in FIG. 1 showing the internal components;

FIG. 3 is an isometric view of the extrusion assembly of the version shown in FIG. 1;

FIG. 4 is a side elevation view of the extrusion assembly of the version shown in FIG. 3;

FIG. 5A is a cross-sectional view of the extrusion assembly shown in FIG. 4;

FIG. 5B is a cross-sectional view of an extrusion assembly using a multi-part barrel with thermal barrier;

FIG. 6 is an isometric cross-sectional view of the extrusion assembly shown in FIG. 4.

FIG. 7 is an isometric view of an alternative horizontal extrusion assembly;

FIG. 8 is a cross-sectional view of the extrusion assembly shown in FIG. 7;

FIG. 9 is an isometric view of a version of the tapered extrusion screw;

FIG. 10 is a cross-sectional view of the version of the tapered extrusion screw shown in FIG. 9;

FIG. 11A is a side plan view of the tapered extrusion screw shown in FIG. 9;

FIG. 11B is an opposite side plan view of the tapered extrusion screw shown in FIG. 9;

FIG. 11C is cross-section of the tapered extrusion screw shown in FIG. 11B taken along lines C-C;

FIG. 12 is a close-up view of the means for dispensing of the version shown in FIG. 5

FIG. 13 is an up-close cross-section view of the narrowing compression end zone of the extrusion assembly as shown in FIG. 12;

FIG. 14 is an isometric view showing use of fans and heat sinks for heat dissipation of the version shown in FIG. 1;

FIG. 15 is a rear isometric view showing the internal components of the version shown in FIG. 1;

FIG. 16 is an isometric view showing the print platform assembly in the raised position of the version shown in FIG. 15;

FIG. 17 is an isometric view showing the print platform assembly in the lowered position of the version shown in FIG. 15;

FIG. 18 an isometric view showing the print platform assembly of the version shown in FIG. 1;

FIG. 19 is an isometric view showing the print platform assembly omitting the print platform of the version shown in FIG. 18;

FIG. 20 is an isometric view showing the print platform of the version shown in FIG. 18;

FIG. 21 is an up-close isometric showing the hub assembly and internal components of the print platform assembly of the version shown in FIG. 18;

FIG. 22 is an isometric showing the internal components of the print platform assembly of the version shown in FIG. 18;

FIG. 23 is a top plan view of the hub assembly of the version shown in FIG. 18;

FIG. 24 is a top plan view of the hub assembly of the version shown in FIG. 18;

FIG. 25 is an isometric view showing the internal components of the print platform assembly of the version shown in FIG. 18;

FIG. 26 is a cross sectional view of the extrusion assembly and print platform assembly of the version shown in FIG. 1;

FIG. 27 is an isometric view illustrating operation of the version shown in FIG. 1;

FIG. 28 is an isometric view illustrating operation of the version shown in FIG. 1;

FIG. 29 is an isometric view illustrating operation of the version shown in FIG. 1;

FIG. 30 is an isometric view illustrating operation of the version shown in FIG. 1;

FIG. 31 is a block diagram of the programmable control system of the operation of the stepper motors;

FIG. 32 is a flowchart showing the motion control system process;

FIG. 33 is an illustration of a resulting 3D path generated by the motion control system;

FIG. 34 is an illustration of a resulting 3D path generated by the motion control system showing overlaid, time-parameterization; and

FIG. 35 is an illustration of a resulting 3D path generated by the motion control system showing overlaid, vectorization of time-parameterization.

### DESCRIPTION

Referring now to the drawings wherein the showings are only for purposes of illustrating a preferred version of the invention and not for purposes of limiting the same.

The following detailed description is of the best currently contemplated modes of carrying out exemplary versions of the invention. The description is not to be taken in the limiting sense, but is made merely for the purpose of illustrating the general principles of the invention, since the scope of the invention is best defined by the appended claims.

Various inventive features are described below that can each be used independently of one another or in combination with other features.

The invention, and all of its embodiments, is an apparatus and process for making three-dimensional physical objects of a predetermined shape by sequentially extruding multiple layers of solidifying material on a print platform in a desired pattern. Preferably, the system is a compact sized printer which utilizes one or more extrusion screws to process a myriad of materials including, but not limited to, plastic, metal, composites and non-metals in order to build 3-dimensional objects.

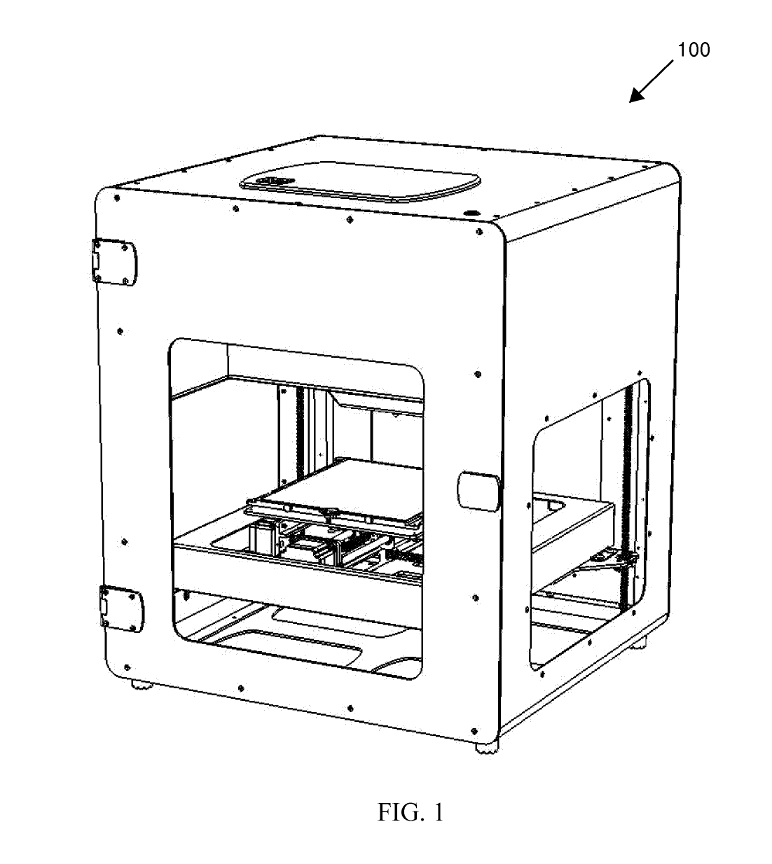

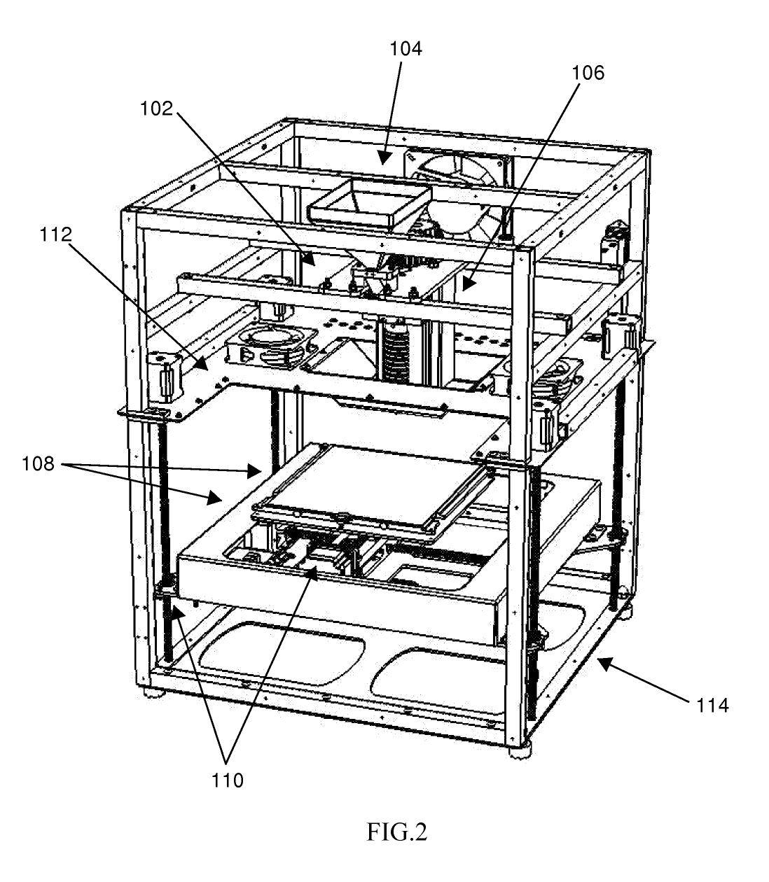

Attention is directed initially to FIG. 1 and FIG. 2 of the drawings, wherein an extrusion system for additive manufacturing and 3D printing is shown in accordance with a first version of the present invention and is shown in use and designated generally by reference numeral 100. The printing system 100 is intended to combine the benefits of the extrusion process—availability of a wide array of print materials—while providing an easy to use, easy to maintain 3D printer.

The printing system 100 generally comprises an extrusion assembly 102, a means for receiving and distributing the solidifying material 104 to the extrusion assembly 102, a means for imparting rotation to the screw 106 at a variable predetermined rate or to a predetermined rotational angle, a print platform assembly 108 disposed in close, working proximity to the extrusion assembly 102, and a mechanical means 110 for moving the extrusion assembly and the print platform relative to each other in multiple dimensions in a predetermined sequence and pattern.

Broadly speaking, the 3D printing system 100 is configured to dispense the processed material onto the print platform assembly 108 in a controlled, precise matter via force from the extrusion process. As the extrusion assembly 102 deposits material, the printing system 100 mechanically generates relative movement of the print platform assembly 108 and the extrusion assembly 108 with respect to each other in a predetermined pattern to form a first layer of the plastic material on the print platform assembly 102. Once a layer of the object is created, the distance between the extrusion assembly 102 and print platform assembly 108 is increased and the process is repeated until a three dimensional shape is created.

Referring to FIG. 1 and FIG. 2, the system is generally a freestanding unit which can be easily transported or may optionally be affixed to a surface. The components of the printing system 100 are retained in their operable relative positions either directly or indirectly by the upper and lower frame assemblies 112 and 114. The sub frames can be any configuration that carries out supporting the components in an operable manner.

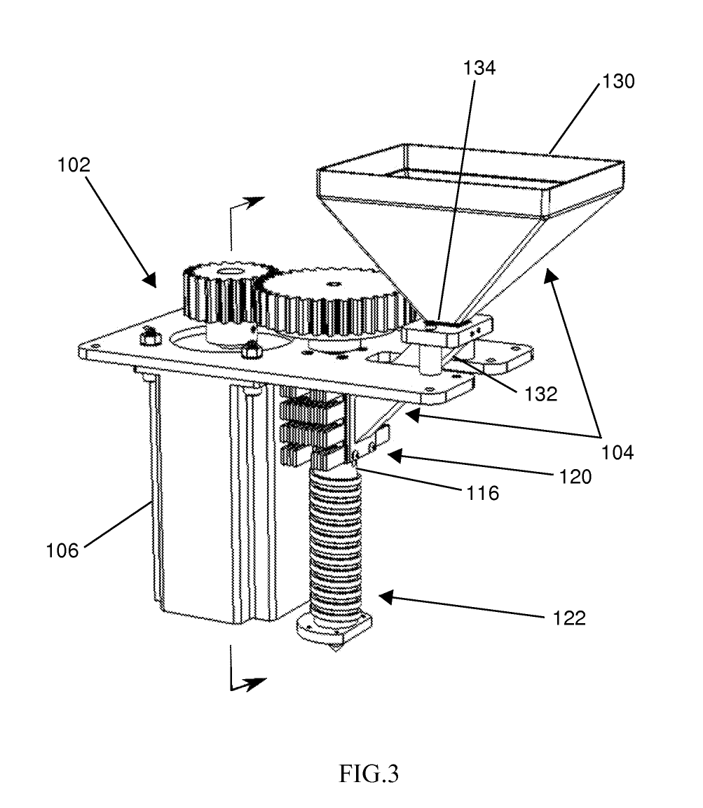

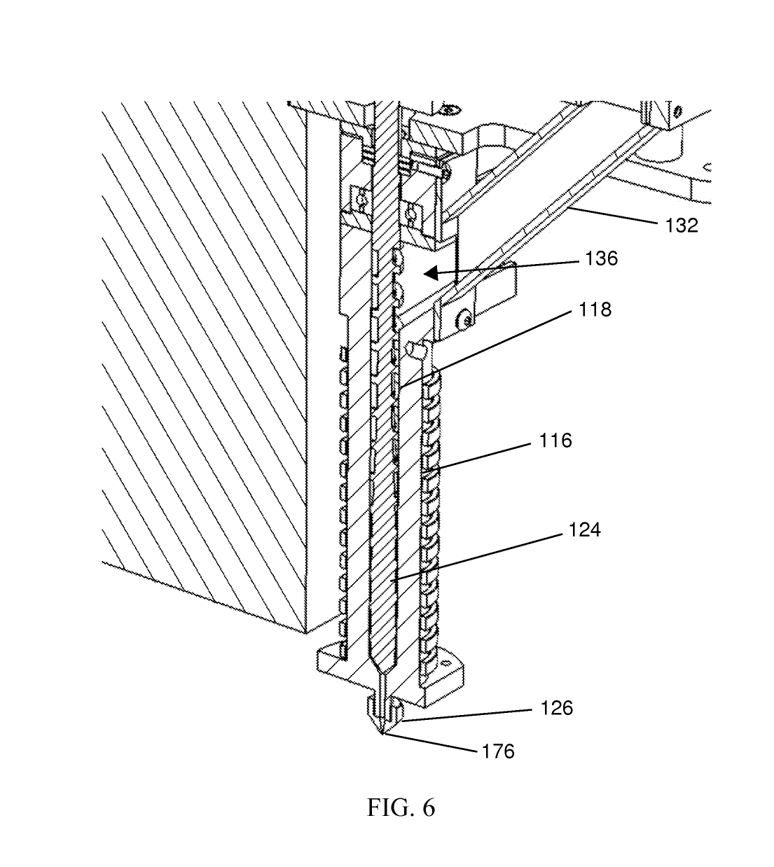

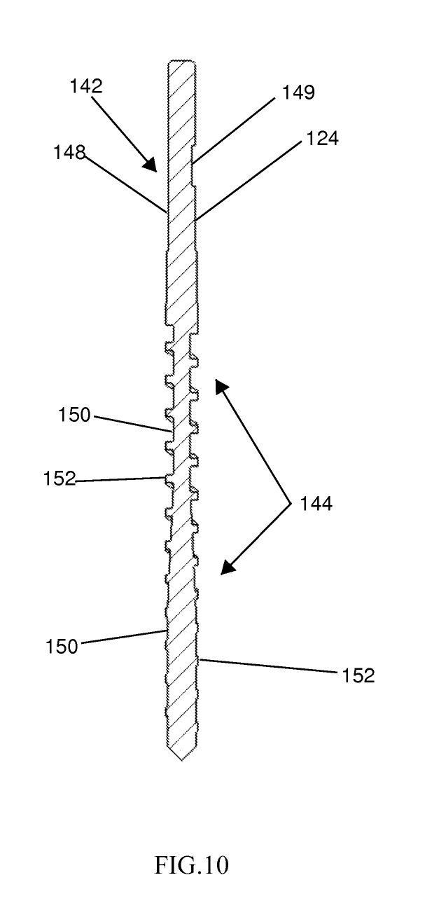

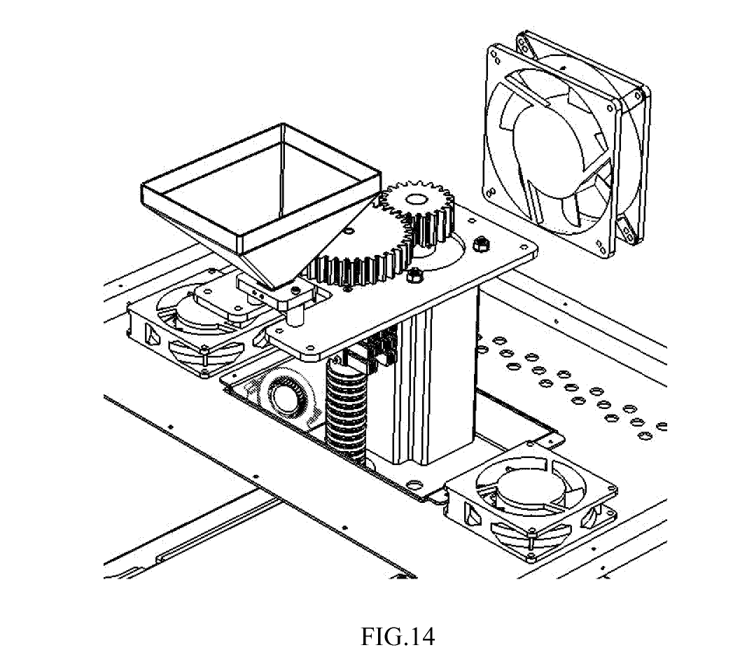

As best illustrated by FIG. 3-FIG. 14, the extrusion assembly 102 will be described initially. In a first version, the extrusion assembly 102 includes a barrel 116 comprising an inner bore 118 forming a cylinder, an upstream end 120, and an oppositely disposed downstream end 122. A screw 124 is rotatably mounted within the inner bore 118 for forcing the solidifying material from the upstream end 120 to the downstream end 122 of the barrel 116. A nozzle 126 for dispensing the molten material is positioned and communicates with the downstream end 122 of the barrel 116. The upstream end 120 of the barrel 116 includes a feed throat zone 136. The feed throat zone 136 is adapted to provide an access point for introducing the solidifying material or plastic pellets to the upstream end of the screw 124.

The barrel 116 can be any casing or containment vessel that provides an inner bore 118 or cylinder that fittingly corresponds with the major diameter 123 of the screw 124. Preferably, the inner bore is a smooth, continuous bore, however, other configurations may be utilized, such as a grooved inner barrel or an inner bore having internal screw flights, or other containment vessel with one or multiple channels.

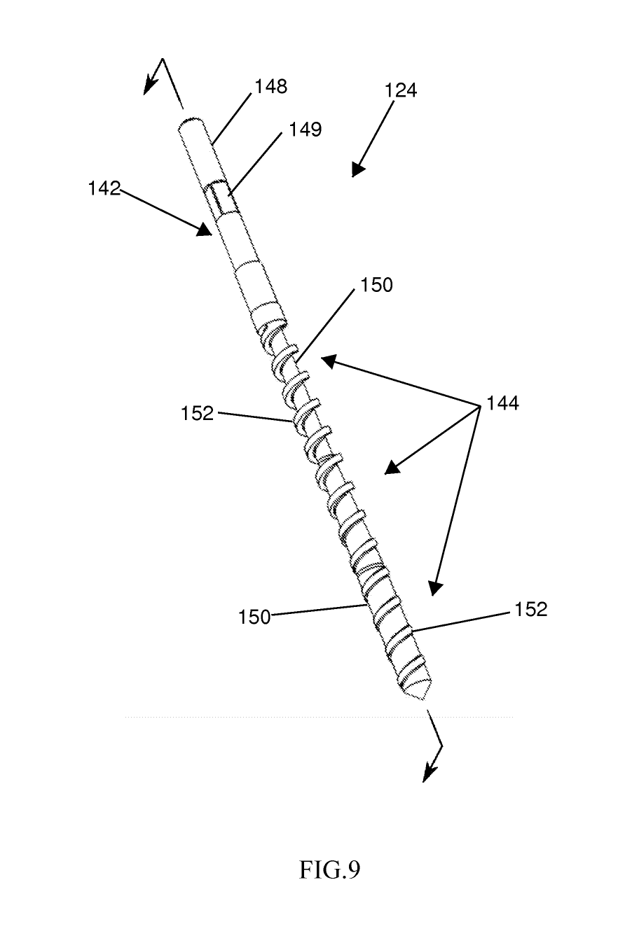

As best illustrated by FIG. 9-FIG. 11C, the extrusion screw 124 will be described next. The extrusion screw 124 may be constructed in many different configurations. However, preferably speaking, the screw 124 comprises a head segment 142, a flight segment 144 and a no-flight end segment 146. In the version the no-flight end segment is conically shaped, therefore other shapes may be utilized. The head segment 142 comprising a stem 148 with a formation pattern 149 adapted to engage with a means for providing a rotational force. The flight segment 144 having a screw root 150 having a variable diameter, affixed to the screw root 150 is at least one helically threaded screw flight 152. The major diameter 123 of the screw formed between the crests of the helically threaded screw flight 152 is ideally constant throughout the length the of flight segment 144.

An important novel aspect of the invention is the relatively short, compact length of the extrusion screw 124. This compact size and configuration is ideal for 3D print applications. Ideally, the extrusion screw 124 flight segment 144 length to major diameter 123 ratio ranges approximately from 15:1 to 24:1, ideally approximately 16:1. Preferably, the major diameter 123 of the extrusion screw 124 ranges from approximately 9 mm to 11 mm, ideally approximately 9.53 mm. The screw flight angle or helix angle preferably ranges from 17 degrees-24 degrees, ideally 17.5 degrees. However, other angles can certainly be utilized depending on the application.

Moreover, the extrusion screw 124 preferably comprises at least one compression zone 154, wherein the root within the compression zone increases in diameter moving downstream while maintaining a constant major diameter 123 formed by the crests of each screw flight 152. Thereby, the cross sectional area of the flow channel 155 decreases, compressing, heating and providing shear force to the solidifying material. It will be known that the compression zone may extend the length of the flight segment 144 or only a portion of the flight segment 144.

In the illustrated version and in particular FIG. 9-11C, the extrusion assembly 102 with screw 124 and barrel 116 is tailored to best process and extrude typical sized, 1 mm-3 mm sphere or cylinder shaped pellets of various plastic materials as known in the art. Furthermore, the version 100 can appropriately extrude pellets as large as 5 mm-7 mm, or as small as fine powder. Materials may include, but are not limited to, PLA, TPU, EVA, HIPS, Nylon, ABS and PC, mostly any thermoplastic material or other composites. Other materials such as low temperature alloys like pewter or other forms of tin may also be utilized.

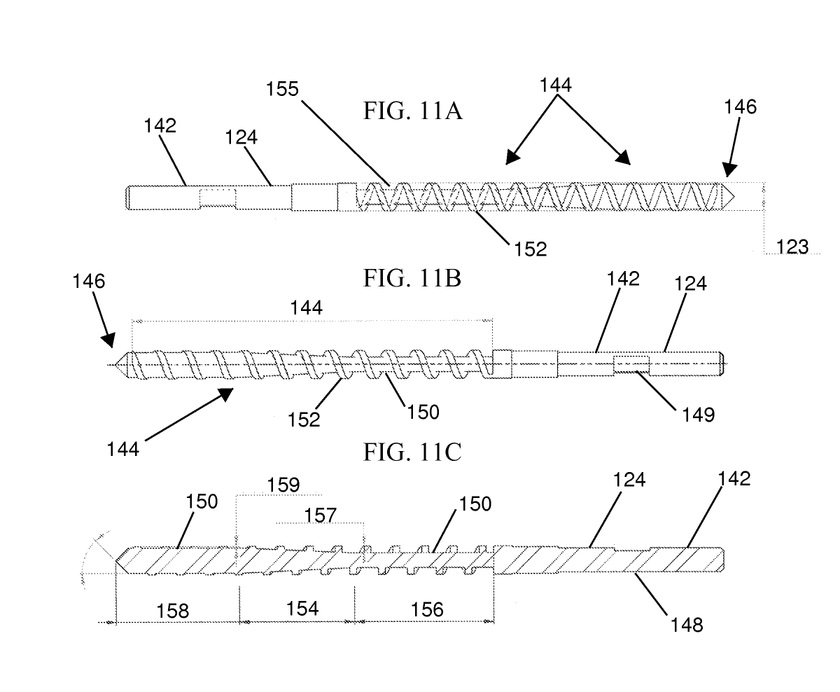

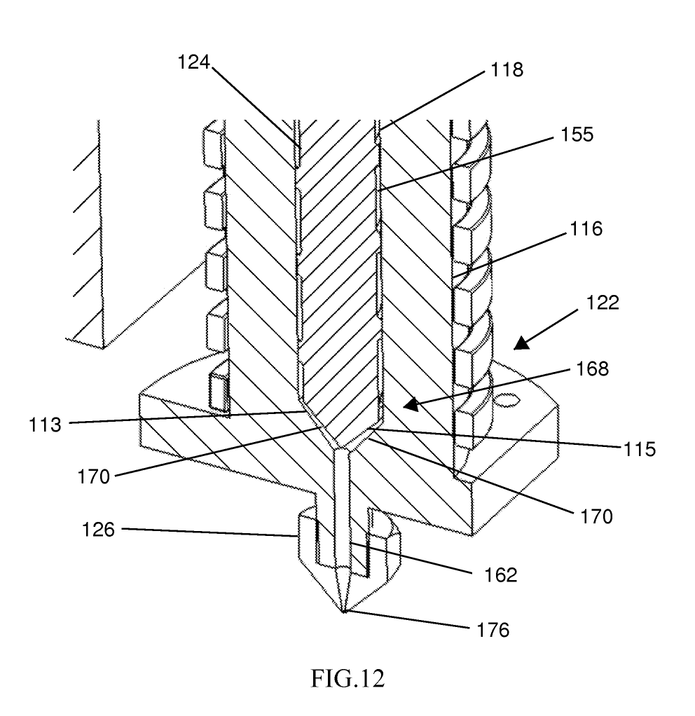

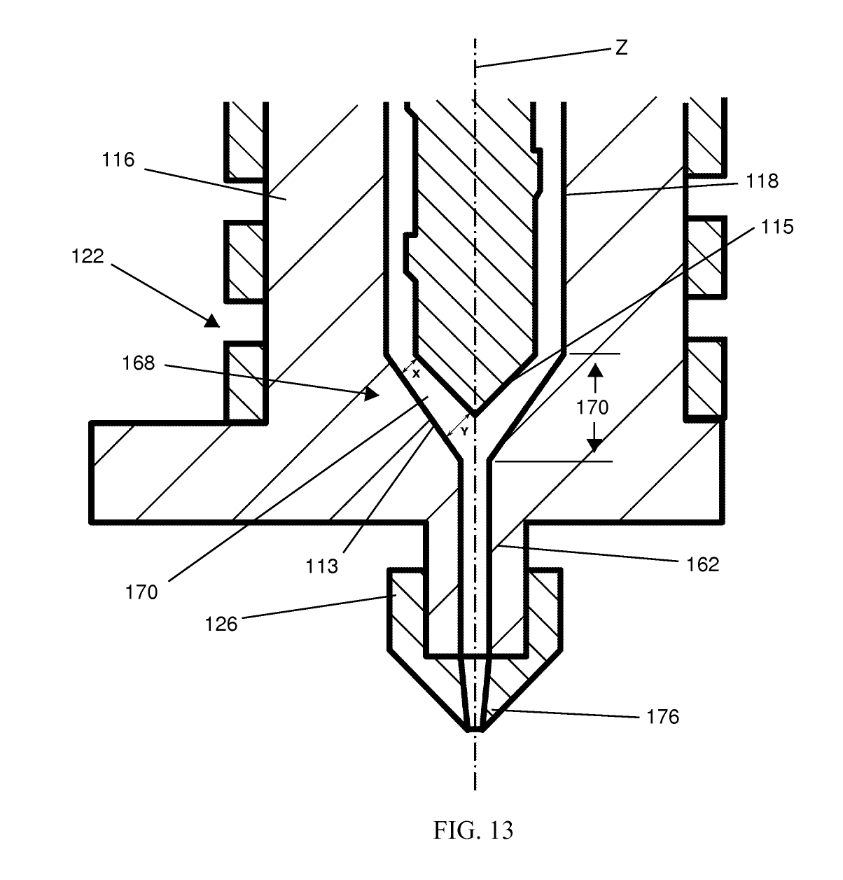

As best illustrated by FIG. 11C, the extrusion screw flight segment 144 ideally comprises a feeding zone 156, a compression zone 154, and a pumping zone 158. The feeding zone 156 is positioned upstream adjacent the feed throat zone 136, wherein the flights within the feeding zone 156 are at their deepest depths and are configured to receive raw solidifying material or ideally plastic material in the form of pellets. The depth 157 of the flights from the root to the crest within the feeding zone 156 are ideally approximately 2.286 mm (millimeters) plus or minus 0.025 mm. The length of the feeding zone 156 is ideally approximately 45 mm to 50 mm or approximately 38% of the entire flight segment 144. The compression zone 154 is located immediately downstream of the feeding zone 156 which is adapted to receive, heat, and compress the solidifying material into a molten condition as discussed above. Preferably, the compression zone 154 has a linear taper reducing the flow channel 155 and flight depth from approximately 2.500 mm to 0.400 mm, ideally 2.286 mm to 0.508 mm plus or minus 0.025 mm. The compression zone 154 length is approximately 36 mm to 43 mm, ideally 37 mm or 30% of the entire flight segment 144. The pumping zone 158 is located immediately downstream of the compression zone 154 adapted to receive, move and distribute the molten solidifying material in a uniform manner to a means for dispensing the solidifying material, or the nozzle 126 and corresponding nozzle channel 162. Ideally, the pumping zone 158 maintains a constant flight depth 159 in order to move print material in a consistent manner.

In the illustrated version, the flight depth 159 within the pumping zone 158 is approximately 0.5 mm to 0.7 mm, ideally 0.508 mm. The pumping zone 158 length is preferably 38 mm to 44 mm, ideally approximately 41.72 mm or approximately 32% of the entire flight segment 144.

In other versions of the extrusion assembly, the screw and barrel may also have other specialized features, including, but not limited to, compression zones, heating zones, cooling zones, venting zones, and colorizing zones. It may also be necessary for the extrusion system to have multiple screws and barrels.

The extrusion screw 124 is controlled and rotated by a means for imparting rotation to the screw 124 at a variable predetermined rate. The means for imparting rotation to the screw 124 is ideally a stepper motor 172 or other type of rotary motion device. In the version 100, the stepper motor 172 cooperates with the screw 124 via meshed gears 174 or other linkage devices such as belts and/or pulleys. The stepper motor 172 is controlled numerically, at a predetermined rate or rotated to a predetermined angle that appropriately matches the movement of the print platform assembly 108.

A nozzle 126 comprising an outlet 176 is provided for dispensing the molten material onto the print platform assembly 108. The nozzle 126 receives molten material from the downstream end 122 of the barrel 116 via nozzle channel 162 (See FIG. 12). Depending on the configuration, the extrusion assembly 102 may have one or more nozzles that molten material is deposited from. These nozzles may have various extrusion profiles, depending on the functionality desired. The volumetric rate and flow through the nozzle 126 is controlled via the extrusion screw 124 rotation rate provided by the stepper motor 172. Alternatively, a mechanical or electrical valve can be utilized to slow or stop flow all together.

Now referring in particular to FIG. 12 and FIG. 13, the version 100 includes a shaped narrowing compression end zone or—for the purposes of this version—a conically shaped compression end zone 168 operably positioned downstream of the barrel 116 inner bore 118 and upstream of the means for dispensing the molten solidifying material or nozzle 126, wherein the conically shaped no-flight end segment 146 of the screw 124 is fitted with the conically shaped narrowing compression end zone 168 forming a compression channel 170 therebetween. The compression channel 170 acts as an inherent valve. For example, as the screw 124 is actuated, the molten print material is forced through the compression channel 170. As the molten material is forced through the channel 170, the pressure accumulation is reduced at the nozzle 126. Once the rotation of the screw 124 is stopped, then slightly reversed or retracted (using a stepper motor), there is an increase in negative pressure which immediately stops molten flow, terminating movement of the solidifying material into the nozzle 126. Thus, significantly providing increased control and precision when dispensing material via the nozzle 126.

The compression channel 170 can take on a linear, tapered or curved flow path. Preferably, the volume of the compression channel 170 is equal to or less than the total volume of a single complete revolution screw pitch-amount of material in the pumping zone 158 or the downstream flight segment immediately preceding the conically shaped narrowing compression end zone 168. This ensures that the pressure in the compression channel 170 is controlled and manageable—and optimal for 3D printing—allowing for increased control of the volumetric flow rate, and assisting with retraction when the screw is rotated in reverse. Preferably, the conically shaped narrowing compression end zone angle formed between the lateral conically shaped narrowing compression end zone surface 113 and screw central longitudinal axis Z (See FIG. 13) is equal to or less than the conically shaped no-flight end segment angle formed between the lateral conically shaped no-flight end segment surface 115 and the screw central longitudinal axis. Ideally, either of the conically shape narrowing compression end zone angle or the conically shaped no-flight end segment angles is approximately 45 degrees. Thus, preferably, the compression channel 170 slightly expands in relative depth between lateral surfaces moving down stream. See emphasized—not drawn to scale—distance X and Y in FIG. 13. Alternatively, a mechanical or electrical valve can be utilized to slow or stop flow all together as opposed to the conically shaped narrowing compression end zone 168 mechanics.

It will be known that the “narrowing compression end zone” does not have to be conical, but can be configured in other shapes which carry out the intended result of decreasing pressure within the nozzle area during extrusion and increasing negative pressure when extrusion is stopped. For example, the narrowing compression end zone 168 may be curved, pyramid shaped, spherical or other various shapes that are fitted with a correspondingly shape “no-flight end segment” of the screw 124. Thus, other variations in shape could be utilized in order to provide a compression channel 170 which slightly expands in relative depth between lateral surfaces moving down stream. The above “conical” configuration is merely an example or a version of the narrowing compression end zone 168.

In the version, the barrel or casing may further comprise a heat source for providing heat to the solidifying material. Ideally the heating source is directed towards the downstream end 122 of the barrel 116 in order to assist with properly increasing the temperature of the solidifying material or plastic material at or above its melting point. The heating source may be provided by an electronic source such as heater bands 164 utilized in version 100, but may include other ways of providing heat such as utilizing microwaves, inductive heating, and electronic arc heating.

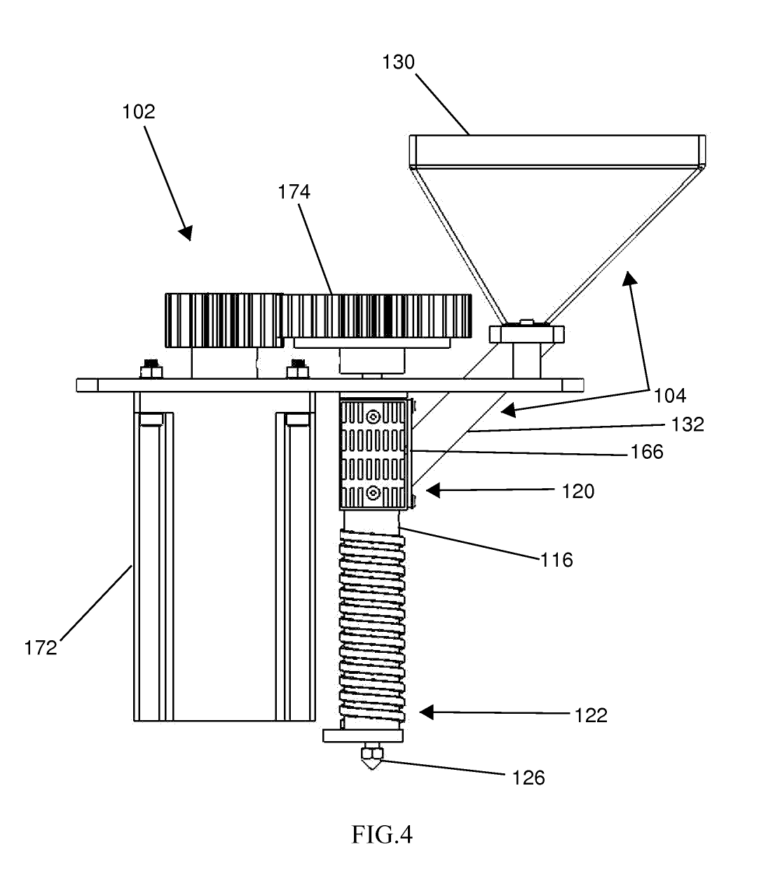

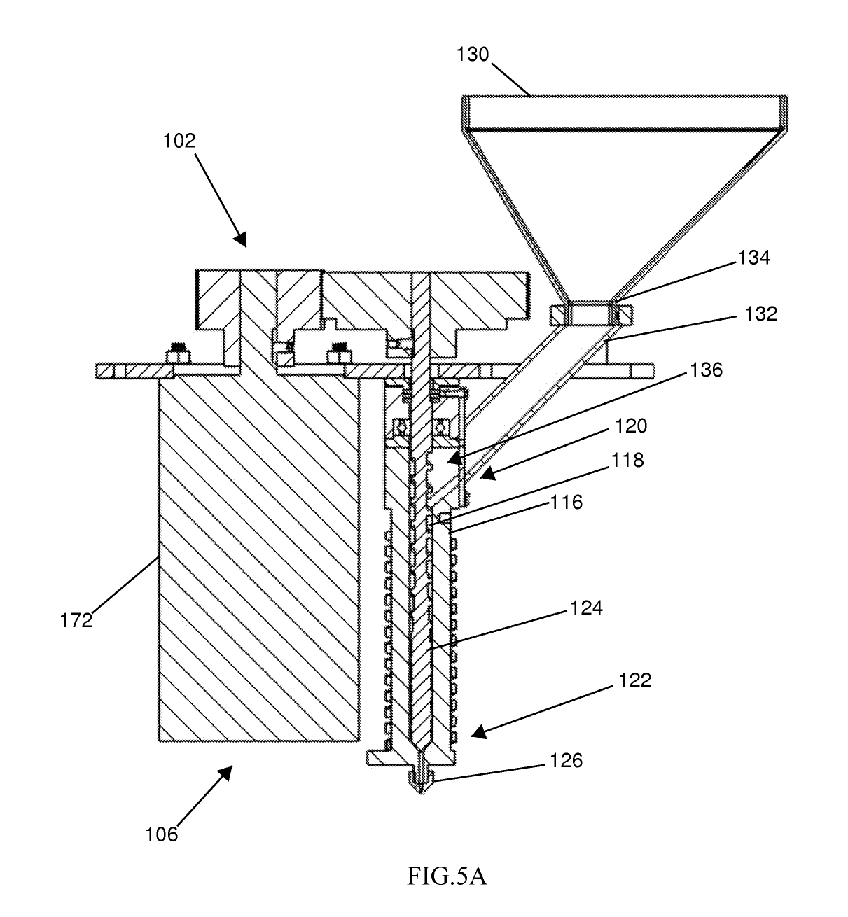

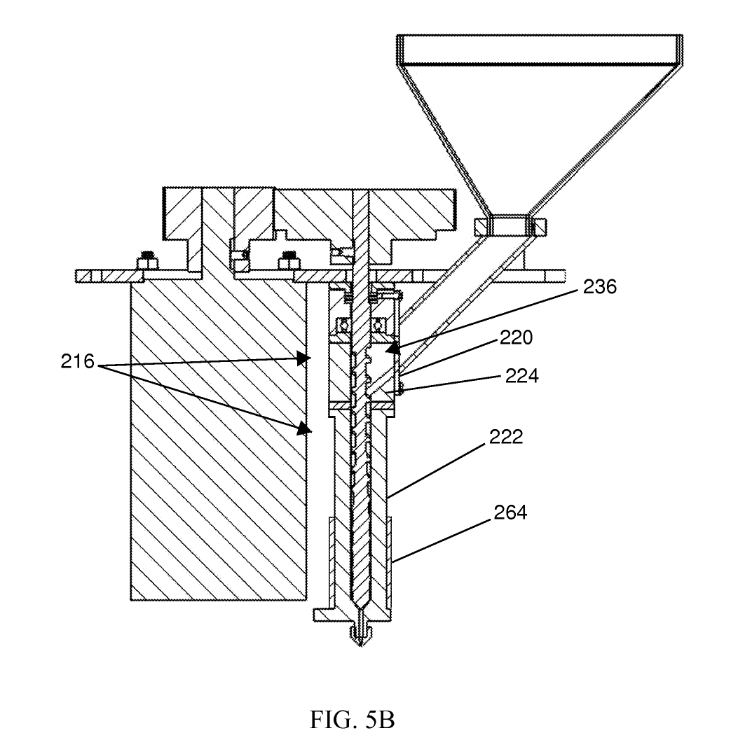

Because of the novel short length and compactness of the extrusion screw 124 and extrusion assembly 102, the accumulation of heat near the feed throat zone 136 of the barrel 116 can become problematic in that the solidifying material or plastic pellets can prematurely melt, resulting in an obstruction at the feed throat zone 136 inhibiting proper movement of the material through the extrusion assembly 102. Thus, a means for removing heat may be introduced near the feed throat zone 136 and the upstream end of the barrel 116 in order to inhibit the accumulation of heat. The means for removing can be a heat sink 166 or any means that effectively removes non-absorbed heat from the area such as a fan. See FIG. 4 and FIG. 5A.

In another version as illustrated by FIG. 5B, a multi-part barrel 216 is provided. The multi-part barrel 216 comprises an upstream non-heated portion 220 and a downstream heated portion 222. The downstream heated portion 222 may be heated by a heater band 264 or other heat source as discussed above. A thermal barrier 224 is positioned between the upstream non-heated portion 220 and the heated portion 222. The thermal barrier 224 inhibits heat transfer from the heated portion 222 to the non-heated portion 220 and can be any material that provides a thermal barrier. For reasons stated above, this provides a barrier in order to properly manage heat away from the feed throat zone 236. As discussed above, heat sinks and fans may be utilized to further assist with heat management with regard to the non-heated portion 220.

A means for supplying the solidifying material 104 to the upstream end 120 of the barrel 116 is provided. In the version, the means for supplying the solidifying material comprises a hopper 130 and chute 132. The hopper 130 is a container of sufficient size resembling the shape of a funnel having a discharge end 134. The hopper 130 is adapted to receive and hold a quantity of solidifying material, ideally plastic resin pellets as known in the plastic printing art. A chute 132 connects the hopper 130 discharge end 134 to the upstream end 120 of the barrel 116 at the feed throat zone 136. The chute provides a channel for the pellets to effectively travel by the use of gravity from the hopper 130 to the feed throat zone 136. Ideally, in a gravity fed configuration, the hopper 130 walls 131 are at 30 degrees from the vertical and the chute 132 is at least 45 degrees from the horizontal. Other material transfer means may be utilized such as a mechanical conveyor (i.e. auger, rotating arm, or vibration mechanism). The hopper 130 can be configured to be fixedly attached or detachable and may be manufactured in different sizes in order to manage varying amounts of print material. The hopper 130 may also couple with one or more sensors that detect material quantity held therein at any given time. It will be known that more than one hopper 130 or means for supplying solidifying material 128 can be utilized in an array in order to for mixing of different colors of print material for a desired end product color.

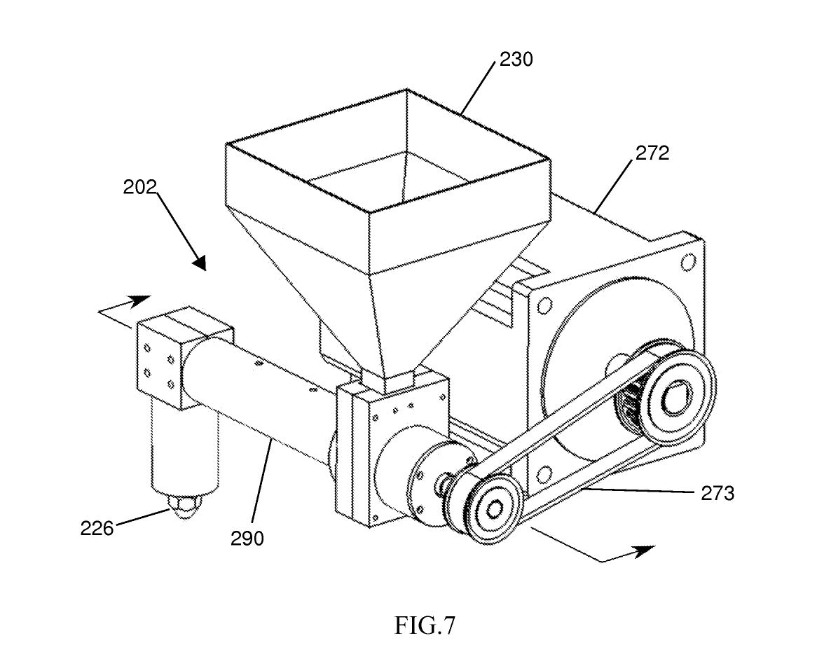

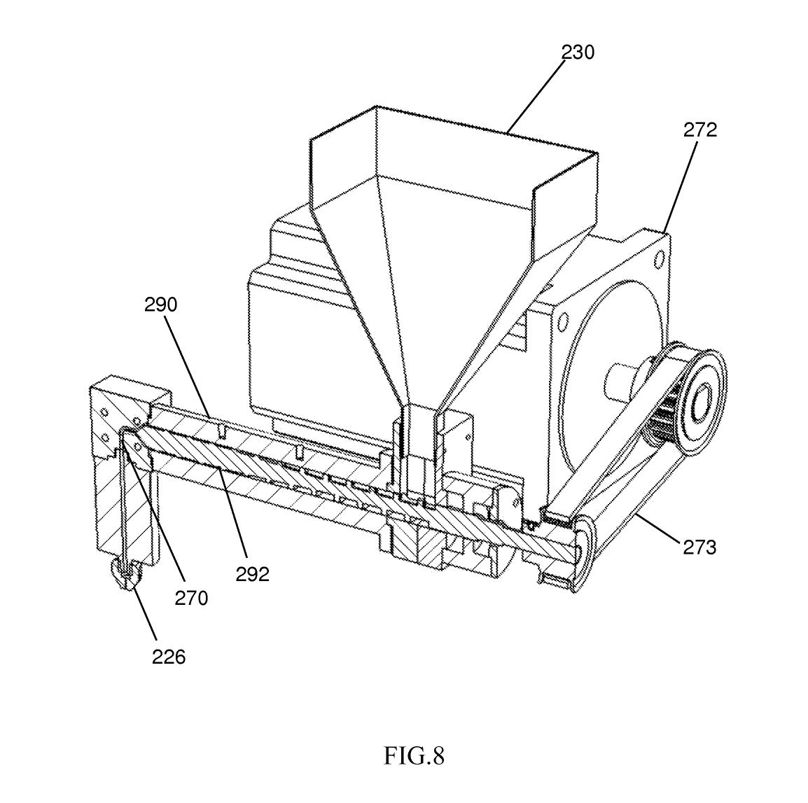

FIG. 7 and FIG. 8 shows an alternative extrusion assembly 202 and hopper 230. The alternative version, includes a horizontally configured barrel 290 and extrusion screw 292 as opposed to a vertical, in line setup. The rotation of the screw 292 is imparted by stepper motor 272 and belt 273. As illustrated, the nozzle channel 270 is configured to provide a 90 degree change in direction of the flow of the molten material to the nozzle 226.

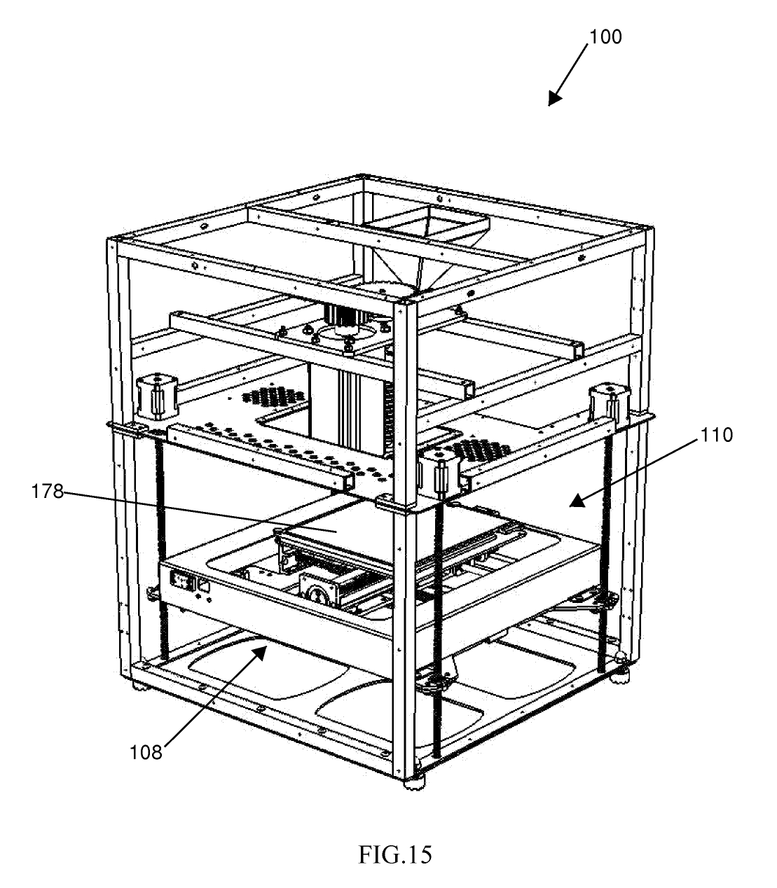

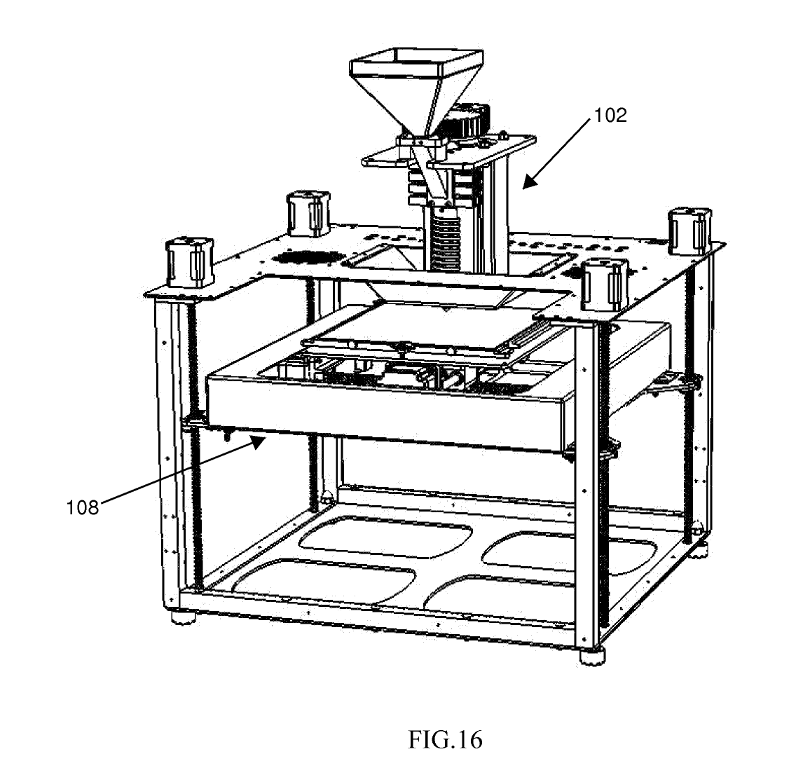

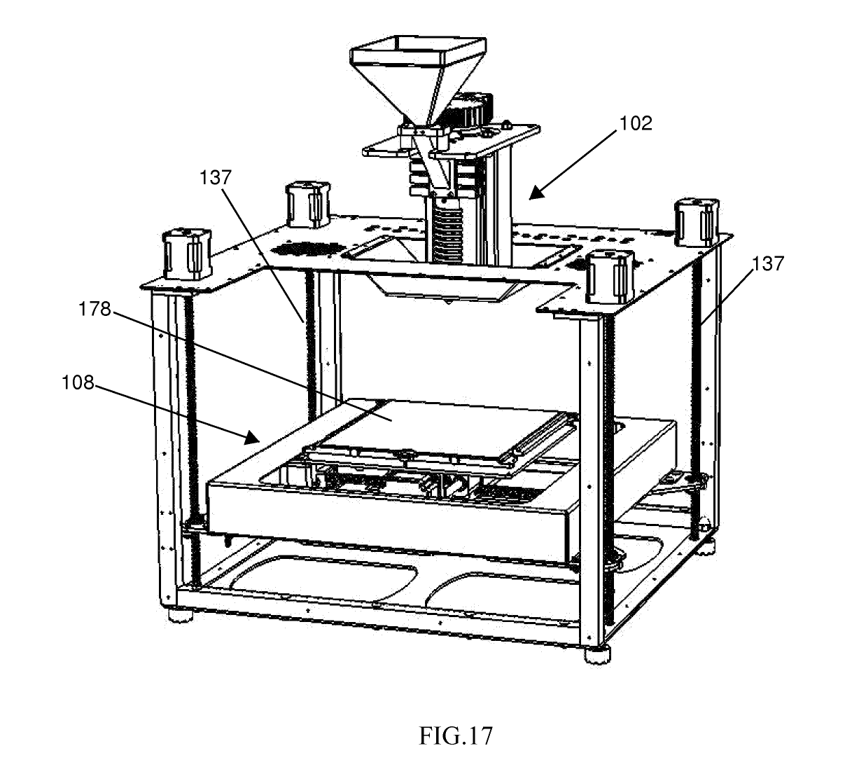

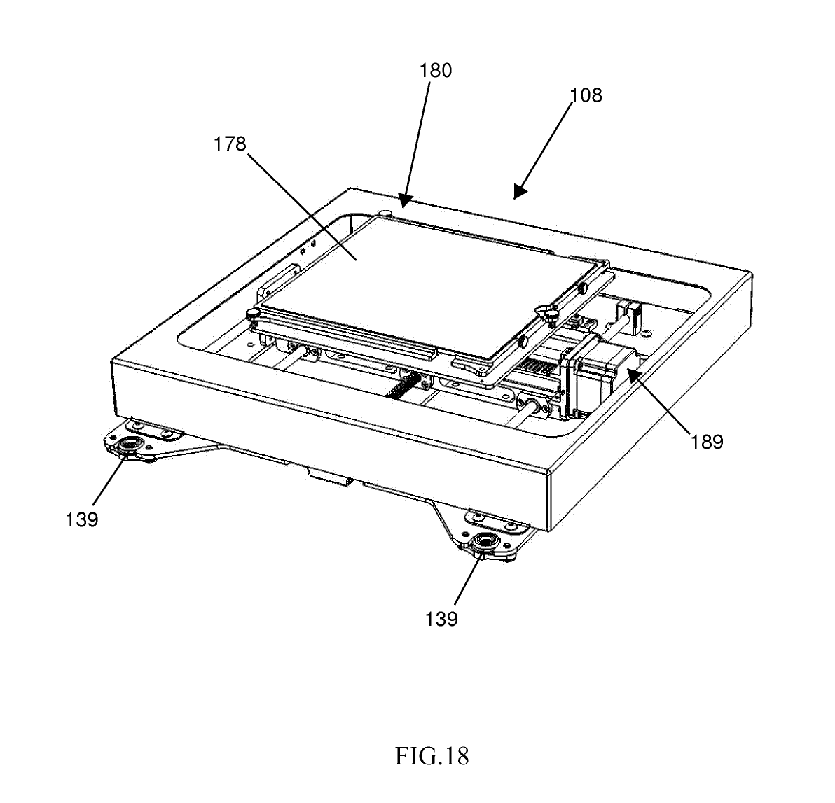

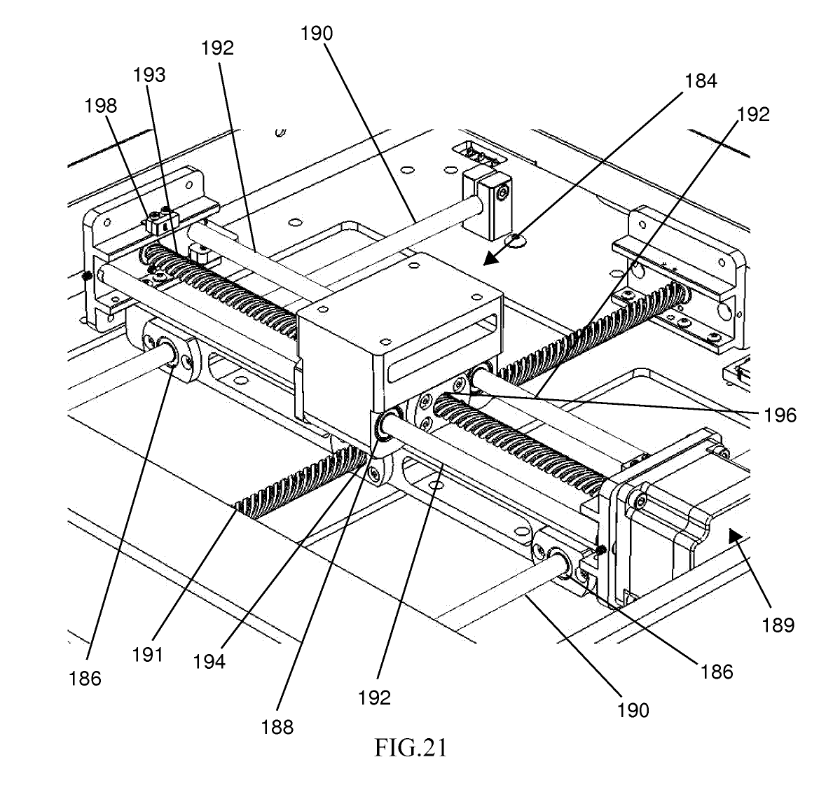

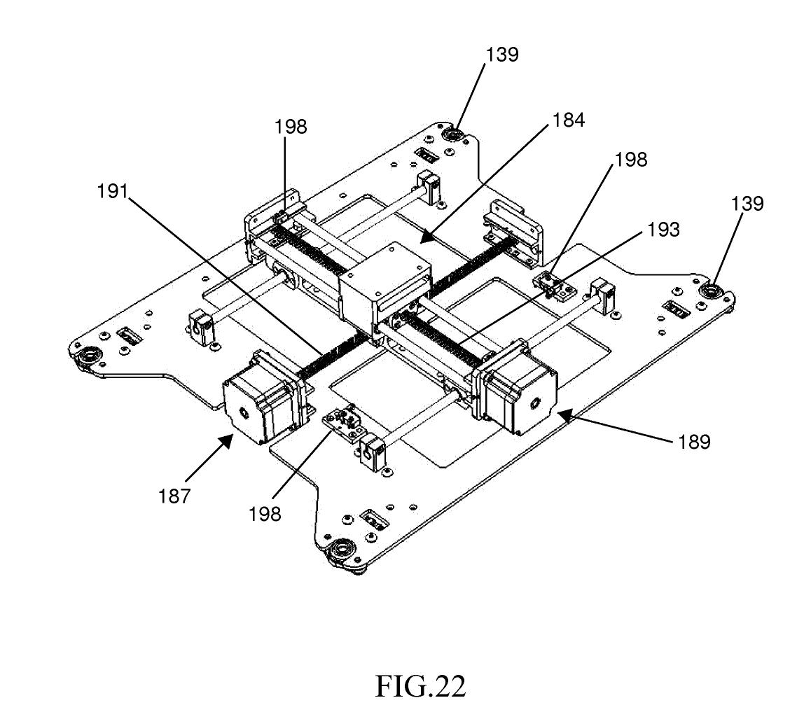

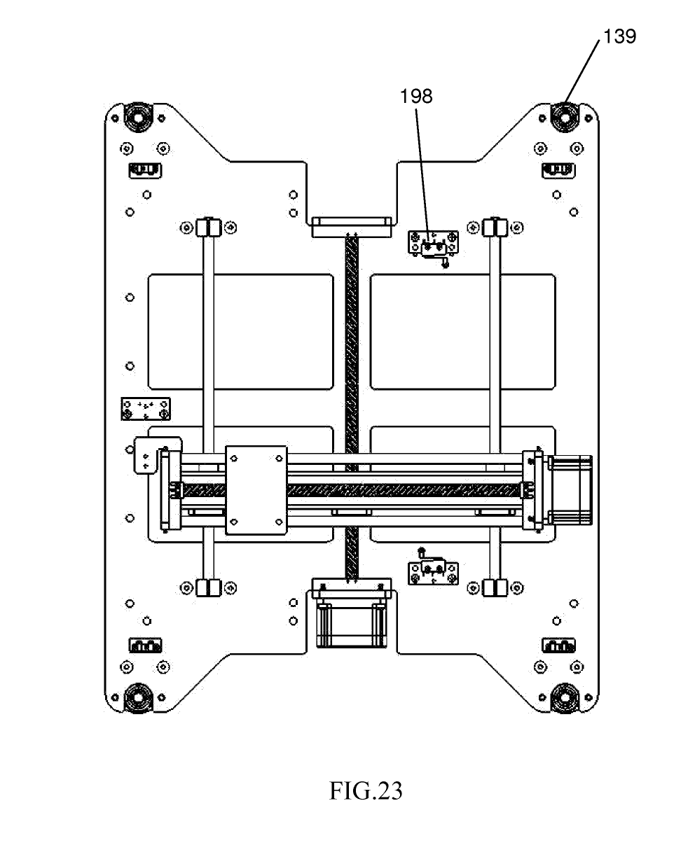

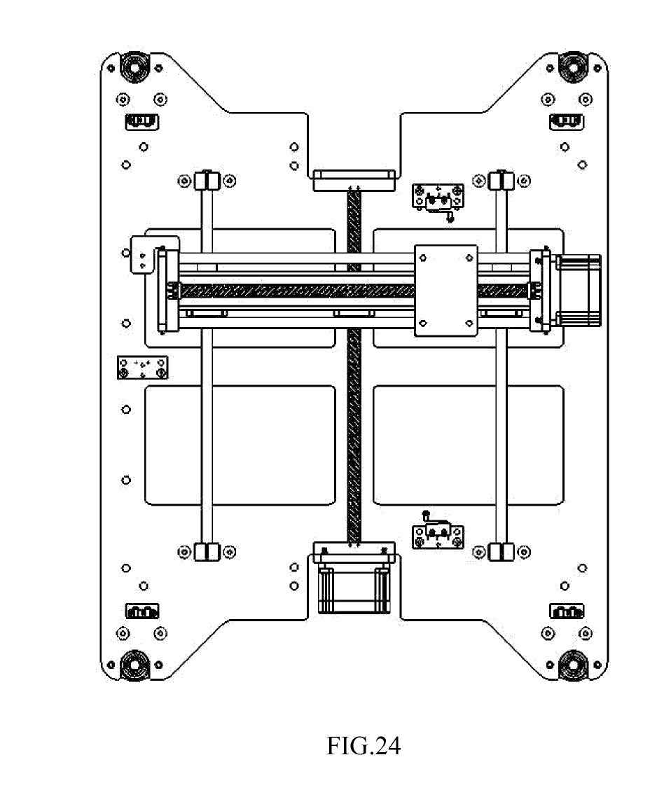

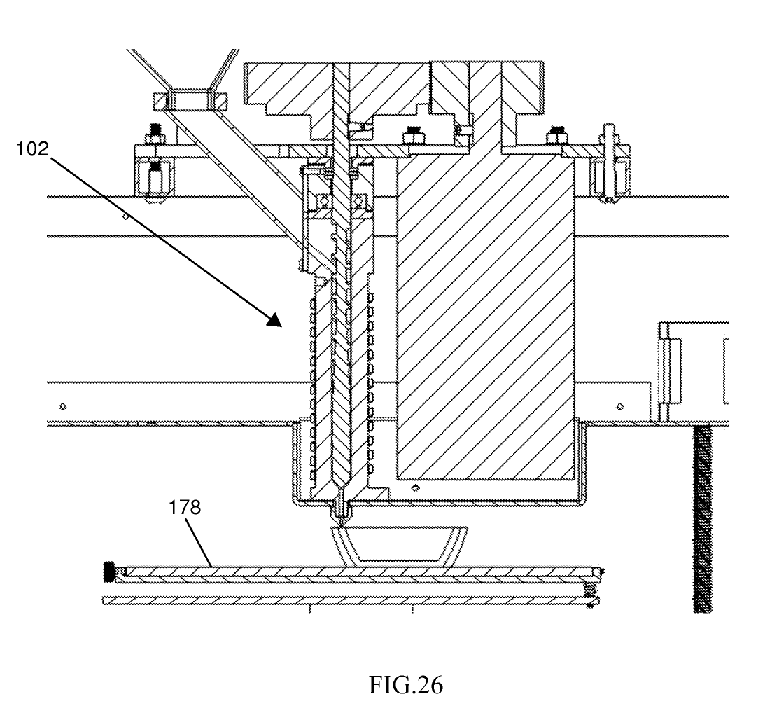

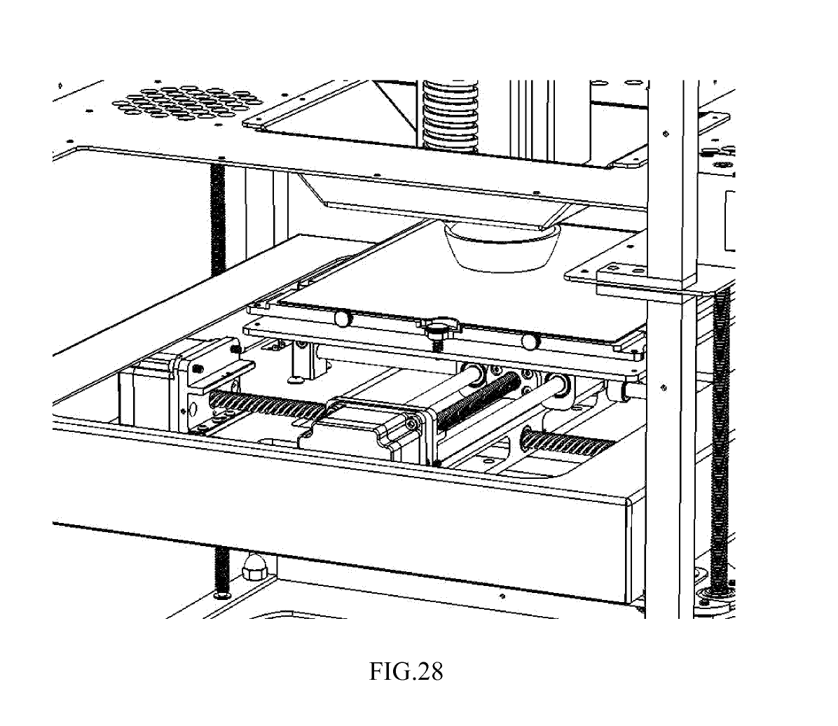

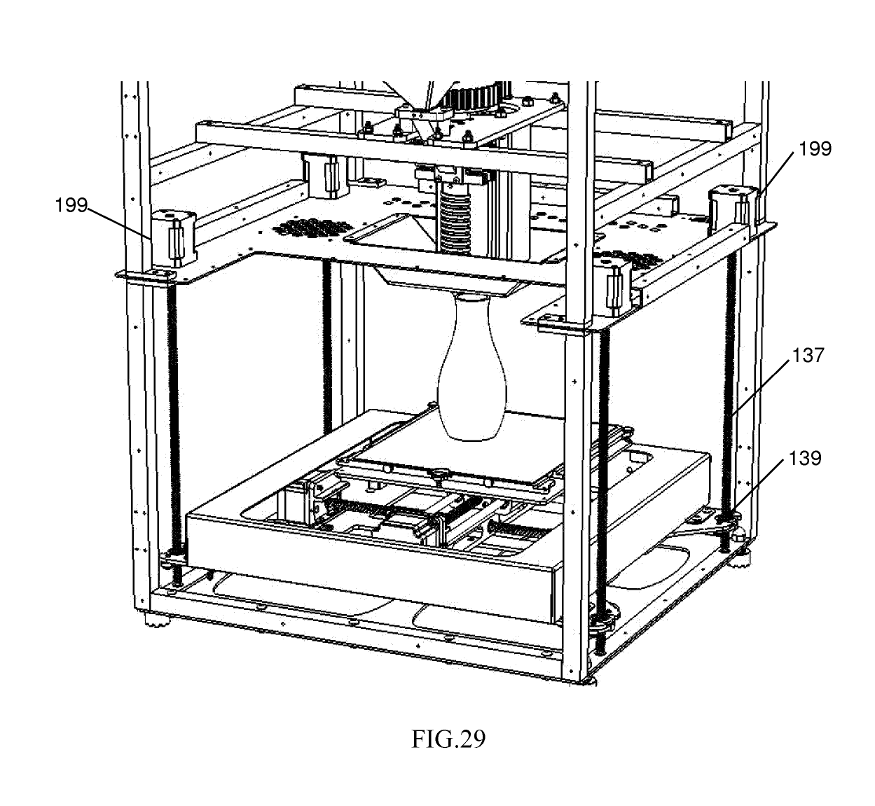

As best illustrated by FIG. 15-FIG. 30, the version 100 comprises a print platform assembly 108 and a mechanical means for moving the extrusion assembly and the print platform 178 relative to each other in multiple dimensions in a predetermined sequence and patters. FIG. 18. represents a front isometric view of the print platform assembly 108. FIG. 17 shows an identical view without the print platform 178. The print platform 178 is a flat piece of material onto which the extrusion assembly 102 deposits print material thereon. In the version, the print platform 178 includes a leveling system 180. The leveling system 180 includes at least three screw type adjusters 182 having the ability to adjust the vertical height at three locations. Adjustment of the screw type adjusters 182 can be carried out either by hand or automatically, via motors or actuators.

The following is a description of the preferred embodiment of the mechanical means 110 for moving the extrusion assembly 102 and the print platform 178 relative to each other in multiple dimensions in a predetermined sequence and pattern. It will be known that either the extrusion assembly, nozzle, or the print platform can be configured to move in 0-infinite dimensions in order to carry out the substance of the invention. Movement of the aforementioned components can be configured in Cartesian, radial, or any other mathematical coordinate language.

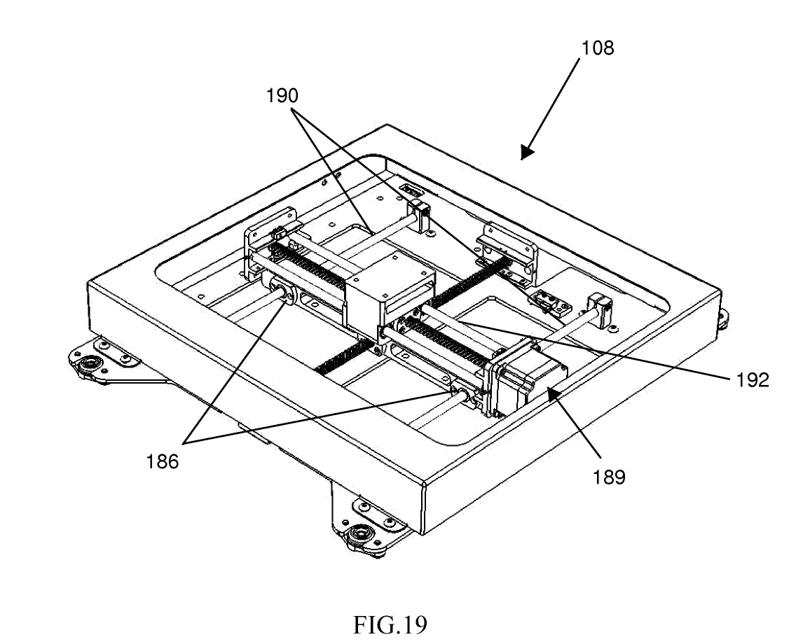

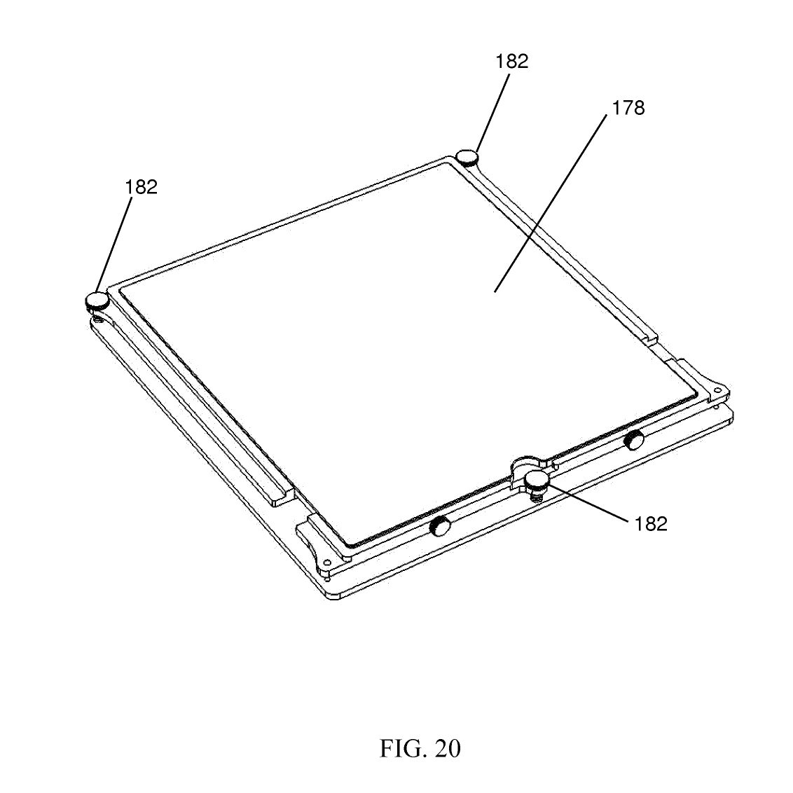

The print platform 178 and leveling system 180 are positioned atop the hub assembly 184. The hub assembly 184 may be configured to move in zero to infinite axis. The hub assembly 184 houses both motion and position components, which can be best seen in FIG. 19. Bearings 186, 188 and corresponding guide rails 190, 192 provide a path of travel in the X and Y directions. The bearings can utilize ball bearings, plain sleeve bearings, bushings or other means of friction reduction or linear motion. The guide rails 190, 192 can be made from a variety of metals, plastic, or other materials. Movement of the hub assembly 184 and print platform 178 along each axis is driven by motors 187, 189. Each motor 187, 189 rotates corresponding lead screws 191, 193, which in turn engages the corresponding lead screw nuts 194, 196 operably embedded within the hub assembly 184. Thus, in order for the hub assembly 184 and print platform 178 to move along a single axis, the motor corresponding to that axis is actuated to provide rotation to the corresponding lead screw in either a clockwise or counterclockwise direction, resulting in positive or negative translation in position on the given axis. For simultaneous motion in multiple axes, multiple motors are actuated in any combination of directions and rates corresponding to a predetermined sequence generated by the processing means or computer. The hub assembly 184 motion may be limited via limit sensors 198 which can be mechanical or electrical sensors. A sample translation of the hub assembly 184 can be seen between FIG. 16 and FIG. 17.

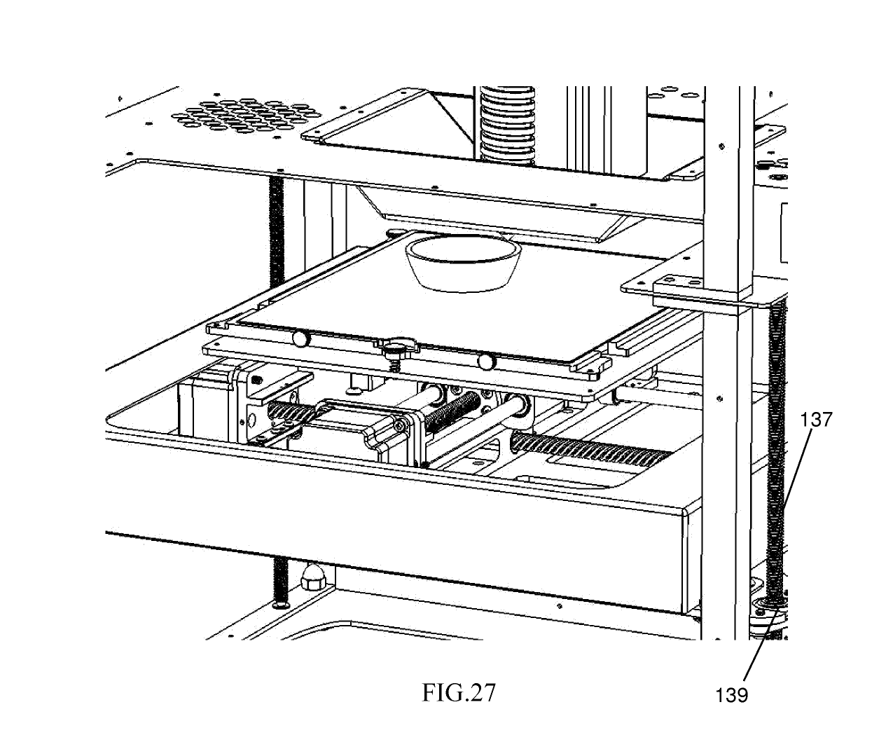

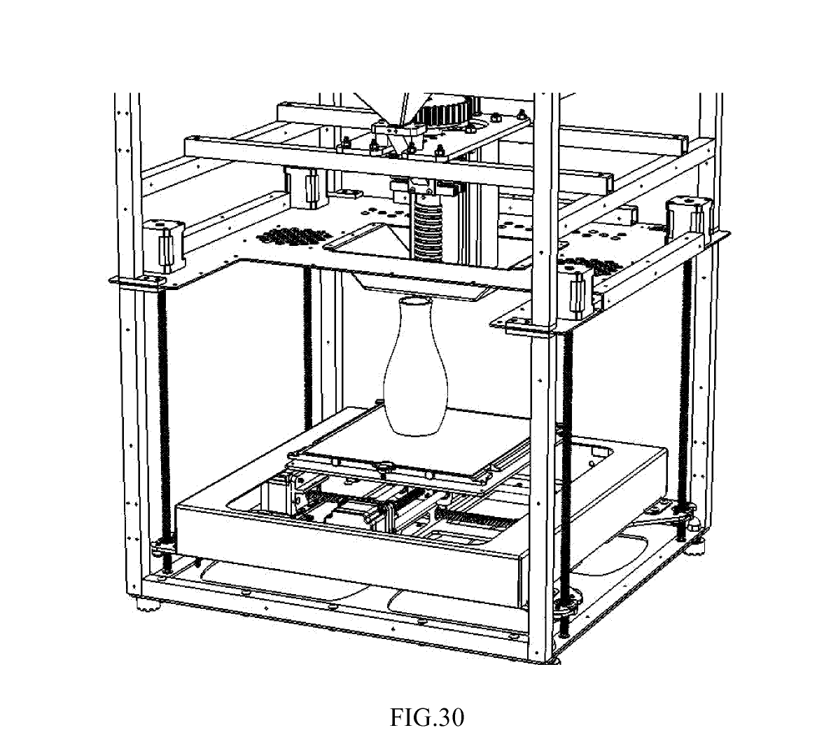

In the version 100, the print platform assembly 108 moves along a vertical or Z axis via two to four motors 199, utilizing lead screws 137 and nuts 139, or belts and pulleys or other mechanical or electrical means. The vertical direction is also limited and calibrated via limit sensors 141, which may be mechanical or electrical sensors. It is also possible to automatically level the print platform using these vertical limit sensors or other sensor means. A sample translation of the print platform while creating an object can be seen between FIG. 27 and FIG. 30.

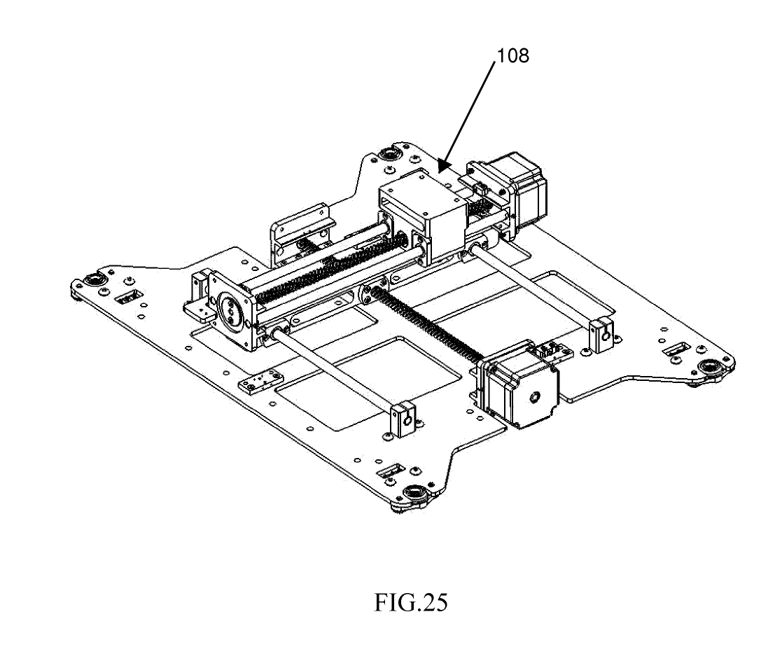

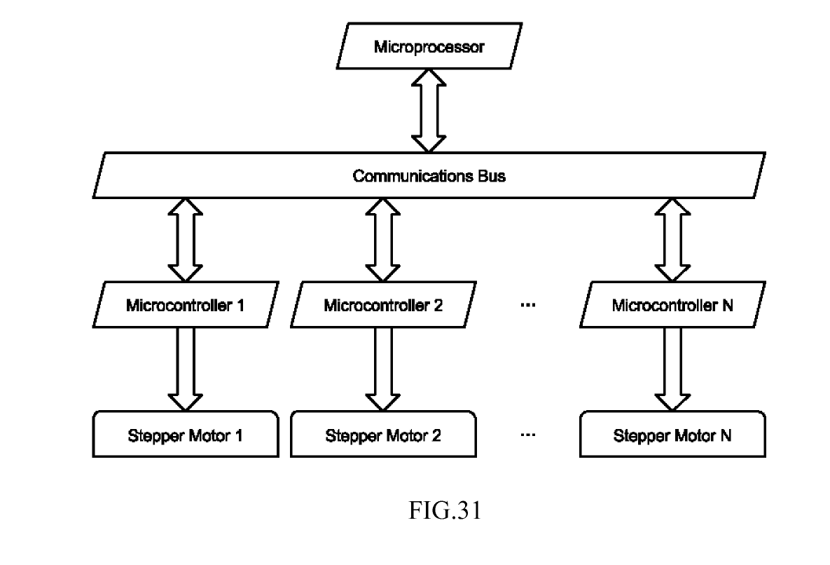

As depicted in the block diagram FIG. 31, motion is numerically controlled via computer and controller, which may be pre-programmed or manually operated. In particular, the composite system motors 172, 187, 189 and 199 are computer-controlled by drive signals generated from a computer or processing means. The object layering data signals are directed to a machine controller from the layering software executed by the processor. The controller in turn is connected to the X, Y, and Z drive motors 187, 189, and 199 and the stepper motor 172, respectively, for selective actuation of those motors by the transmission of the layering drive signals. Thus, as the extrusion assembly 102 deposits material, the hub assembly 184 and print platform 178 is moved in one, two, three, or more dimensions at a predetermined vector. Once a layer of the object is created, the distance between the extruder nozzle and print platform is increased and the process is repeated until a three dimensional shape is created. This process can be observed in FIG. 25-FIG. 28.

At present, computerized control systems of maintaining synchronization of and directing the movements of multiple motors require frequent monitoring of and modifications to the states of each independent motor, requiring significant allocation of computational and monitoring resources.

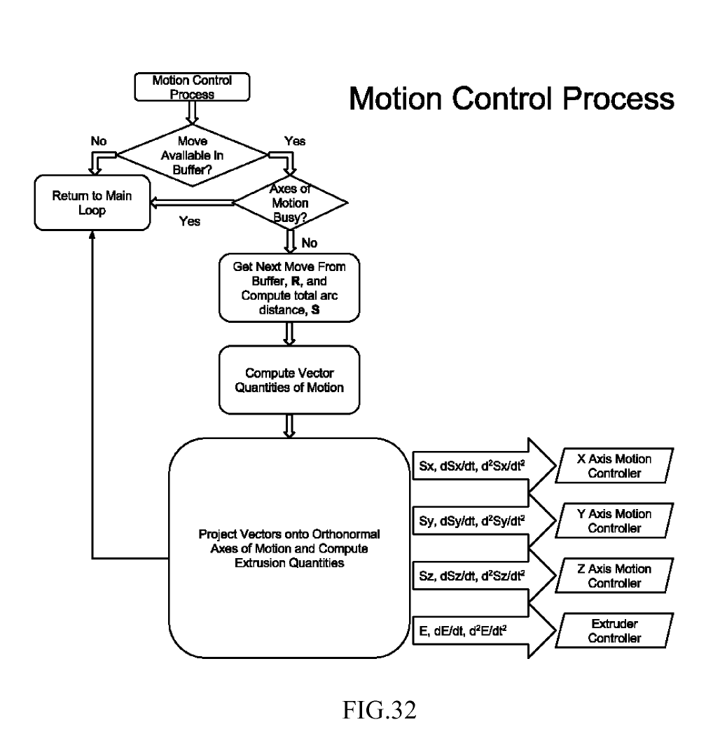

Referring to FIG. 32, the presently disclosed version of the invention utilizes a computer control system utilizes an algorithm which embodies synchronization in time of the movement of one or more motor axes that are each operated independently of the others in order to precisely move the composite motor system in three-dimensional space and time. Motion of the composite motor system defines a three-dimensional path that can be approximated by a series of three-dimensional displacement vectors; thus the composite motor system can be moved along these displacement vectors serially in order to reproduce the motion of the original path. Quantities of motion are then calculated for each displacement vector. Because motion in each individual motor axis is parallel to one and only one coordinate axis, the quantities of motion for each displacement vector can be projected, via vector decomposition, onto the corresponding, parallel coordinate axis by an algorithm running on the central microprocessor and dispatched to the corresponding microcontroller(s) of the necessary motor axis(es). Each independent motor axis then begins execution of the motion using the specified quantities of motion and, in such a manner, is synchronized such that the overall displacement vector and thus three-dimensional path is preserved in space and time. It will be known that other computerized control system coordinate methodology as known in the art may be utilized in an alternative version in order to carry out the intended movement between the print platform 178 and the extrusion assembly 102.

More particularly and as illustrated in FIG. 31, a control system that utilizes one microprocessor, one or more microcontrollers, a communications bus between them, and one or more stepper motors is provided. A three-dimensional path, which represents the composite motion to be executed, is approximated by a series of displacement vectors. The central microprocessor executes an algorithm by which the quantities of motion, which include but are not limited to distance, velocity, and acceleration, are computed for each displacement vector. These quantities of motion are then projected, by means of vector decomposition, or other methods, onto the coordinate axes. Because the motion of each independent motor axis, which is composed of one or more stepper motors and one microcontroller, is parallel to one and only one coordinate axis, the quantities of motion for each motor axis are those of the displacement vector that have been projected onto the corresponding coordinate axis and then scaled by a constant factor which is determined by the means by which the independent motor axis is mechanically coupled to the composite motion. Once these quantities of motion have been calculated, projected, and scaled, they are communicated to each of the microcontrollers that then execute the motion independently of the others. In such a manner are the motion represented by each displacement vector and, thus the path, reconstituted by the sum of the motion of the independent motor axes.

A block diagram of the connections of the microprocessor to and from each microcontroller through the bus and each microcontroller's connection to its one or more stepper motors is given in FIG. 31. Running on the microprocessor is a main loop, which determines when and if it is necessary to perform a composite motion, at which time it executes the Motion Control Algorithm, which is represented by the flowchart in FIG. 32. Conditions for determining the appropriateness of executing the next composite motion include, but are not limited to, availability of such a motion and demonstrated by availability of displacement vector data on the microcontroller representing the move and availability of each independent axis of motion, defined by the individual microcontroller and its specified stepper motor(s), to perform such an action.

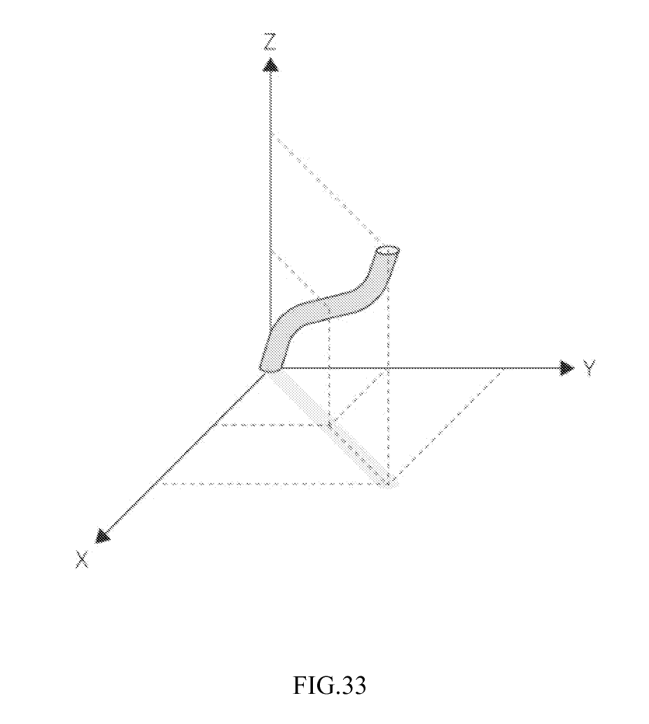

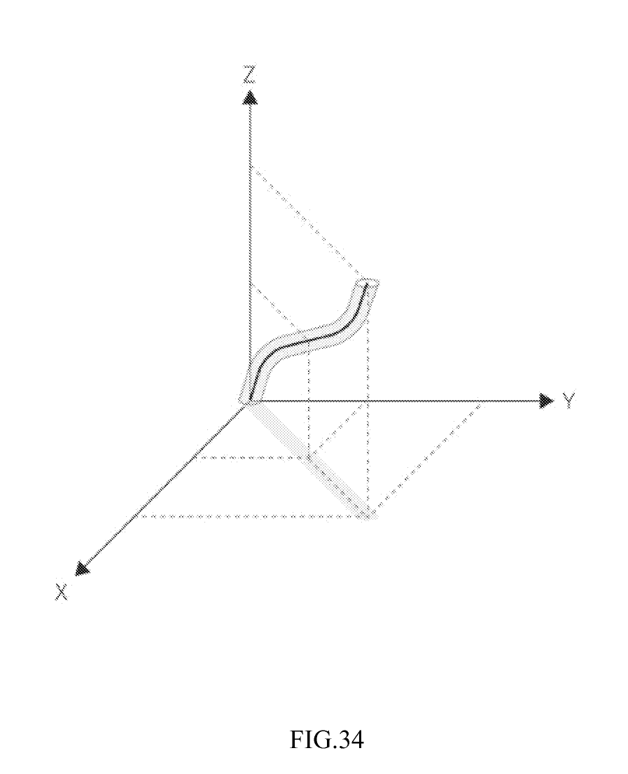

The composite motion through space (FIG. 33) can be represented as a function (FIG. 34), R(t), which is parameterized of time, t, for t₀≦t≦t_{N}. This path can be approximated as a series of displacement vectors (FIG. 33), {R₁, R₂, . . . , R_{N}}, where Rᵢ≡R(tᵢ)−R(tᵢ₋₁). While the number of points on the parameterized path is infinite, a finite number of displacement vectors can be chosen in such a manner that the overall contour or shape of the path is maintained, i.e.,

$$0 < ( 1 - \frac{R ( t ) - R ( {t}_{i - 1} )}{\vert R ( t ) - R ( {t}_{i - 1} ) \vert} \cdot \frac{{R}_{i}}{\vert {R}_{i} \vert} ) < ∈$$

for sufficiently small ε.

The composite motion along the path can then be thought of as a series of linear motions, described by the displacement vectors, to be serially executed by the system. When executed, The Motion Control Algorithm retrieves the next displacement vector, Rᵢ, and computes the quantities of motion, dRᵢ/dt and d²Rᵢ/dt². The algorithm then computes the projections of these vector quantities onto the coordinate axes,

Rₑ=R·ê,

dRₑ/dt=(dR/dt)·\hat{e}, and

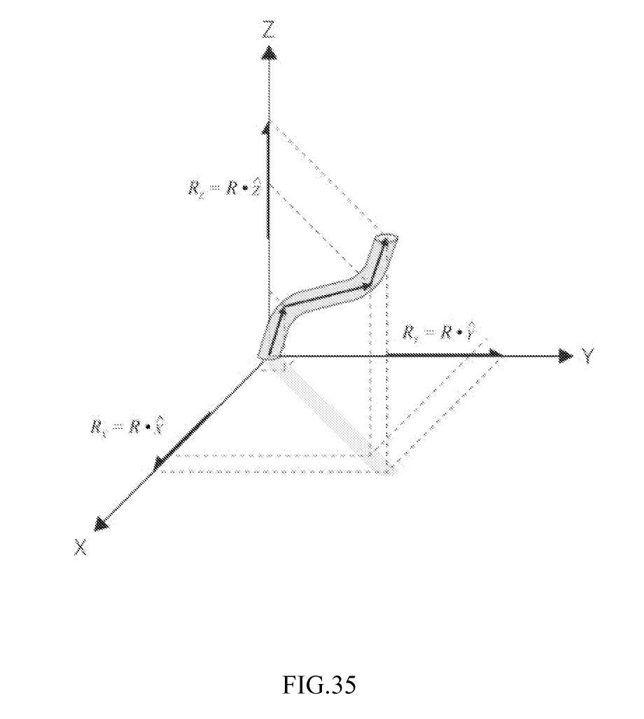

d²Rₑ/dt²=(d²R/dt²)·\hat{e}

where ê is the coordinate axis unit vector, as demonstrated in FIG. 35.

As each microcontroller controls the motion of one or more stepper motors, the independent motion of which is parallel to one coordinate axis, the algorithm selections the appropriate projections of each quantity of motion and scales them by a constant that is determined by the mechanism by which the independent motion of the stepper motor is coupled to the composite motion,

Sᵢ=kᵢRₑ,

dSᵢ/dt=kᵢ(dRₑ/dt), and

d²Sᵢ/dt²=kᵢ(d²Rₑ/dt²)

where i is the index to the microcontroller, e is the index to the appropriate coordinate axis, k is the appropriate scalar constant determined by the mechanism by which the motor's output is couple to the physical system, S is the number of steps to be executed by the stepper motor, dS/dt is the speed of the stepper motor, and d²S/dt² is the acceleration and deceleration of the stepper motor.

After all such quantities have been computed for each microcontroller, the microprocessor sends this data to them via the bus and instructs the microcontrollers to begin executing the move. Once given these quantities and the command to begin executing, each microcontroller moves its assigned stepper motor(s) according to the given quantities of motion until the specified number of steps has been completed. As quantities of motion for each microcontroller are projections of these same quantities for the composite motion and each microcontroller begins execution simultaneously, they finish execution simultaneously and remain synchronized throughout the motion without further need for monitoring or intervention, thereby maintaining the direction and magnitude of the displacement vector and thus the entire path.

The composite motion is determined to be completed when all independent axes of motion have completed their assigned motions and the microcontrollers communicate their availability for further instruction to the microprocessor.

The process for making three-dimensional physical objects of a predetermined shape by sequentially extruding multiple layers of a solidifying material on a print platform in a desired pattern will now be described in detail. Firstly, an extrusion assembly as described above is provided comprising at least: (i) a barrel 116 comprising an inner bore 118 forming a cylinder, an upstream end 120, and an oppositely disposed downstream end 122; (ii) a screw 124 rotatably mounted within the inner bore 118 for forcing the solidifying material from the upstream end 120 to the downstream end 122 of the barrel 116, the screw 124 comprising a flight segment 144 having a screw root 150 and affixed to the screw root at least one helically threaded screw flight 152; and a nozzle 126 for dispensing the molten material having an outlet 176 communicating with the downstream end 122 of the barrel 116. Next, at least a print platform 178 and a stepper motor 106 or other means for imparting rotation to the screw is provided.

Secondly, the solidifying material is supplied to the screw 124 at the upstream end 120 of the barrel 116. Simultaneously, with the supplying of the solidifying material to the screw 124 at the upstream end 120 of the barrel 116, a controlled predetermined sequenced rotation of the screw 124 is imparted by the stepper motor 106, thereby initiating and controlling the volumetric rate at which the plastic material flows downstream through the extrusion assembly 102, compressing the solid material into a molten state. Next, dispensing the plastic material from the nozzle 126 in a controlled, precise manner at which it solidifies onto the print platform 178 positioned in close proximity to the means for dispensing the molten material or nozzle 126. Simultaneously with the dispensing of the material onto the print platform 178, mechanically generating relative movement of the print platform 178 and the nozzle 126 with respect to each other in a predetermined pattern to form a first layer of the plastic material on the print platform 178.

Next, displacing the nozzle 126 a predetermined layer thickness distance from the first layer, dispensing a second layer of the material in a molten state onto the first layer from the dispensing outlet while simultaneously moving the print platform and the nozzle relative to each other, whereby the second layer solidifies upon cooling and adheres to the first layer to form a three-dimensional object.

Finally, forming multiple layers of the material built up on top of each other in multiple passes by repeated dispensing of the material in a molten state from the nozzle outlet 176 as the print platform 178 and the nozzle 126 are moved relative to each other, with the nozzle 126 and the print platform 178 being displaced a predetermined distance after each preceding layer is formed, and with the dispensing of each successive layer being controlled to take place after the material in the preceding layer immediately adjacent to the nozzle 126 has solidified.

The process above may be carried out utilizing a conically shaped narrowing compression end zone 168 operably positioned downstream of the barrel 116 inner bore 118 and upstream of the nozzle 126 for dispensing the molten solidifying material as described above, wherein the screw 124 further comprises a conically shaped no-flight end segment 146, and wherein the conically shaped no-flight end segment 146 of the screw 124 is fitted with the conically shaped narrowing compression end zone 168 forming a compression channel 170 therebetween, thereby reducing pressure at the nozzle 126 during extrusion and increases the negative pressure during retraction or when the screw is stopped, thereby increasing accuracy of control of dispensing of the molten solidifying material to the print platform 178.

Preferably, the volume of the compression channel 170 may equal to or less than the total volume of a single revolution screw pitch-amount of material in the downstream flight segment immediately preceding the conically shaped narrowing compression end zone 168.

Alternatively, the conically shaped narrowing compression end zone 168 angle formed between the lateral conically shaped narrowing compression end zone 168 surface and screw 124 central longitudinal axis may be equal to or less than the conically shaped no-flight end segment angle formed between the lateral conically shaped no-flight end segment surface and the screw central longitudinal axis.

Moreover, the process for making three-dimensional physical may further implement a screw 124—as described above—comprising a feeding zone 156, a compression zone 154, and a pumping zone 158, the feeding zone 156 configured to receive the solid material located upstream, the compression zone 154 located downstream of the feeding zone 156 adapted to receive, heat, and compress the solidifying material into a molten condition, and the pumping zone 158 is located downstream of the compression zone 154 adapted to receive, move and distribute the molten plastic material in a uniform manner to the means for dispensing the molten plastic material.

Even further, the process may comprise heating the plastic material as it passes downstream to a temperature above its solidification temperature, and controlling the temperature of said material within a range of plus or minus one degree centigrade of said temperature.

It will be known, that other limitations or combinations may be utilized in conjunction with the above listed process.

The present invention can be made in any manner and of any material chosen with sound engineering judgment. Preferably, materials will be strong, lightweight, long lasting, economic, and ergonomic such as plastic piping or polyvinyl chloride piping (PVC).

The invention does not require that all the advantageous features and all the advantages need to be incorporated into every version of the invention.

Although preferred versions of the invention have been described in considerable detail, other versions of the invention are possible.

All the features disclosed in this specification (including and accompanying claims, abstract, and drawings) may be replaced by alternative features serving the same, equivalent or similar purpose unless expressly stated otherwise. Thus, unless stated otherwise, each feature disclosed is one example only of a generic series of equivalent or similar features.

1.-23. (canceled)

24. An apparatus for making three-dimensional physical objects of a predetermined shape by sequentially extruding multiple layers of solidifying material in a desired pattern, comprising:
(a) an extrusion assembly, comprising:
(i) a barrel comprising an inner bore forming a cylinder, an upstream end, and an oppositely disposed downstream end;
(ii) a screw rotatably mounted within the inner bore for forcing the solidifying material from the upstream end to the downstream end of the barrel, the screw comprising a flight segment having a screw root and affixed to the screw root at least one helically threaded screw flight; and
(iii) a nozzle for dispensing the molten solidifying material having an outlet communicating with the downstream end of the barrel;
(b) a means for supplying the solidifying material to the upstream end of the barrel;
(c) a means for imparting rotation to the screw;
(d) a print platform disposed in close, working proximity to the extrusion assembly; and
(e) a mechanical means for moving the nozzle and the print platform relative to each other in multiple dimensions in a predetermined sequence and pattern.

25. The apparatus of claim 24, wherein the screw further comprises at least one compression zone, wherein the root within the compression zone increases in diameter moving downstream while maintaining a constant major diameter.

26. The apparatus of claim 25, wherein the compression zone extends substantially the length of the flight segment of the screw.

27. The apparatus of claim 25, wherein the flight segment of the screw further comprises a feeding zone, a compression zone, and a pumping zone, the feeding zone configured to receive raw solidifying material located upstream, the compression zone located downstream of the feeding zone adapted to receive, heat, and compress the solidifying material into a molten condition, and the pumping zone is located downstream of the compression zone adapted to receive, move and distribute the molten solidifying material in a uniform manner to the nozzle for dispensing the solidifying material.

28. The apparatus of claim 27, wherein the screw further comprises a no-flight end segment and the barrel further comprises a narrowing compression end zone, the narrowing compression end zone operably positioned downstream of the barrel inner bore and upstream of the nozzle for dispensing the molten solidifying material, wherein the no-flight end segment of the screw is fitted with the narrowing compression end zone forming a compression channel therebetween.

29. The apparatus of claim 28, wherein the compression channel expands in relative depth between the lateral narrowing compression end zone surface and the lateral no-flight end segment surface moving downstream.

30. The apparatus of claim 28, wherein the narrowing compression end zone is conically shaped and the no-flight end segment is correspondingly conically shaped, and wherein the compression channel expands in relative depth between the lateral narrowing compression end zone surface and the lateral no-flight end segment surface moving downstream.

31. The apparatus of claim 28, wherein the volume of the compression channel is equal to or less than the total volume of a single revolution screw pitch-amount of material in the pumping zone of the screw.

32. The apparatus of claim 28, wherein the narrowing compression end zone is conically shaped and the no-flight end segment is correspondingly conically shaped, wherein the angle formed between the lateral narrowing compression end zone surface and screw central longitudinal axis is equal to or less than the no-flight end segment angle formed between the lateral no-flight end segment surface and the screw central longitudinal axis.

33. The apparatus of claim 24, wherein the screw further comprises a no-flight end segment and the barrel further comprises a narrowing compression end zone, the narrowing compression end zone operably positioned downstream of the barrel inner bore and upstream of-the nozzle for dispensing the molten solidifying material, wherein the no-flight end segment of the screw is fitted with the narrowing compression end zone forming a compression channel therebetween.

34. The apparatus of claim 33, wherein the volume of the compression channel is equal to or less than the total volume of a single revolution screw pitch-amount of material in the downstream flight segment immediately preceding the narrowing compression end zone.

35. The apparatus of claim 33, wherein the narrowing compression end zone is conically shaped and the no-flight end segment is correspondingly conically shaped, wherein the angle formed between the lateral narrowing compression end zone surface and screw central longitudinal axis is equal to or less than the no-flight end segment angle formed between the lateral no-flight end segment surface and the screw central longitudinal axis.

36. The apparatus of claim 35, wherein the angle formed between the no-flight end segment surface and the screw central longitudinal axis of greater than or equal to 45 degrees.

37. The apparatus of claim 35, wherein the angle formed between the lateral narrowing compression end zone surface and screw central longitudinal axis is of less than or equal to 45 degrees.

38. The apparatus of claim 24, further comprising a heat source for providing heat to the solidifying material in order to aid in the extrusion process.

39. The apparatus of claim 38, wherein the heat source is one or more heater bands operably positioned around the barrel to effectively apply heat to the solidifying material moving through the cylinder.

40. The apparatus of claim 39, further comprising a means for removing heat from the upstream end of the barrel in order to inhibit heat accumulation where the solidifying material is being distributed from the means for supplying the solidifying material to the upstream end of the barrel.

41. The apparatus of claim 24, wherein the barrel further comprises an upstream non-heated portion and a downstream heated portion thermally separated by a thermal barrier, thereby inhibiting heat transfer from the heated portion to the upstream non-heated portion.

42. The apparatus of claim 24, wherein the means for imparting rotation to the screw at a variable predetermined rate is a stepper motor, thereby providing increased control in order to vary the rate of flow or stop the solidifying material in conjunction with the movement of the mechanical means for moving the extrusion assembly and the print platform relative to each other in order to form a three-dimensional object with accuracy and precision.

43. Apparatus for making three-dimensional physical objects of a predetermined shape by sequentially extruding multiple layers of solidifying material in a desired pattern, comprising:
(a) an extrusion assembly, comprising:
(i) a barrel comprising an inner bore forming a cylinder, an upstream end, and an oppositely disposed downstream end;
(ii) a screw rotatably mounted within the inner bore for forcing the solidifying material from the upstream end to the downstream end of the barrel, the screw comprising a flight segment having a screw root, affixed to the screw root at least one helically threaded screw flight, and a conically shaped no-flight end segment;
(iii) a nozzle for dispensing the molten solidifying material having an outlet communicating with the downstream end of the barrel; and
(iv) a conically shaped narrowing compression end zone operably positioned downstream of the barrel inner bore and the nozzle for dispensing the molten solidifying material, wherein the conically shaped no-flight end segment of the screw is fitted with the conically shaped narrowing compression end zone forming a compression channel therebetween.
(b) a means for supplying the solidifying material to the upstream end of the barrel;
(c) a stepper motor for imparting rotation to the screw;
(d) a print platform disposed in close, working proximity to the extrusion assembly;
(e) a mechanical means for moving the extrusion assembly and the print platform relative to each other in multiple dimensions in a predetermined sequence and pattern;
(f) a heat source for providing heat to the solidifying material in order to aid in the extrusion process; and
(g) a means for removing heat from the upstream end of the barrel in order to inhibit heat accumulation where the solidifying material is being distributed from the means for supplying the solidifying material to the upstream end of the barrel; and
wherein the screw flight segment further comprises a feeding zone, a compression zone, a pumping zone, and a conically shaped no-flight end segment, the feeding zone configured to receive raw solidifying material located upstream, the compression zone located downstream of the feeding zone adapted to receive, heat, and compress the solidifying material into a molten condition, and the pumping zone is located downstream of the compression zone adapted to receive, move and distribute the molten solidifying material in a uniform manner to the nozzle for dispensing the solidifying material.

44. A process for making three-dimensional physical objects of a predetermined shape by sequentially extruding multiple layers of a solidifying material in a desired pattern, comprising:
(a) providing an extrusion assembly comprising:
(i) a barrel comprising an inner bore forming a cylinder, an upstream end, and an oppositely disposed downstream end;
(ii) a screw rotatably mounted within the inner bore for forcing the solidifying material from the upstream end to the downstream end of the barrel, the screw comprising a flight segment having a screw root and affixed to the screw root at least one helically threaded screw flight; and
(iii) a nozzle for dispensing the molten solidifying material having an outlet communicating with the downstream end of the barrel; and
(b) providing a print platform;
(c) providing a stepper motor for imparting rotation to the screw at a variable predetermined rate or to a predetermined rotation angle sequence;
(d) supplying the solidifying material to the screw at the upstream end of the barrel;
(e) simultaneously with the supplying the solidifying material to the screw at the upstream end of the barrel, imparting a controlled predetermined sequenced rotation of the screw, thereby controlling the volumetric rate at which the solidifying material flows downstream through the extrusion assembly, compressing the solid material into a molten state; and
(f) dispensing the molten solidifying material from the nozzle for dispensing the molten solidifying material in a controlled, precise manner at which it solidifies onto the print platform positioned in close proximity to the nozzle for dispensing the molten solidifying material;
(g) simultaneously with the dispensing of the solidifying material onto the print platform, mechanically generating relative movement of the print platform and the nozzle with respect to each other in a predetermined pattern to form a first layer of the plastic material on the print platform; and
(h) displacing the nozzle a predetermined layer thickness distance from the first layer, dispensing a second layer of the solidifying material in a molten state onto the first layer from the dispensing outlet while simultaneously moving the base member and the nozzle relative to each other, whereby the second layer solidifies upon cooling and adheres to the first layer to form a three-dimensional object; and
(i) forming multiple layers of the material built up on top of each other in multiple passes by repeated dispensing of the solidifying material in a molten state from the nozzle outlet as the print platform and the nozzle are moved relative to each other, with the nozzle and the print platform being displaced a predetermined distance after each preceding layer is formed, and with the dispensing of each successive layer being controlled to take place after the material in the preceding layer immediately adjacent to the nozzle has solidified.

45. The process of claim 44, wherein the screw further comprises a no-flight end segment and the barrel further comprises a narrowing compression end zone, the narrowing compression end zone operably positioned downstream of the barrel inner bore and upstream of the nozzle for dispensing the molten solidifying material, wherein the no-flight end segment of the screw is fitted with the narrowing compression end zone forming a compression channel therebetween, thereby reducing pressure at the nozzle during extrusion and increases the negative pressure during retraction or when the screw is stopped, thereby increasing accuracy of control of dispensing of the molten solidifying material to the print platform.

46. The process of claim 45, wherein the volume of the compression channel is equal to or less than the total volume of a single revolution screw pitch-amount of material in the downstream flight segment immediately preceding the compression zone.

47. The process of claim 45, wherein the angle formed between the lateral narrowing compression end zone surface and the screw central longitudinal axis is equal to or less than the angle formed between the lateral no-flight end segment surface and the screw central longitudinal axis.

48. The process of claim 45, wherein the compression channel expands in relative depth between the lateral narrowing compression end zone surface and the lateral no-flight end segment surface moving downstream.

49. The process of claim 45, wherein the screw further comprises a feeding zone, a compression zone, and a pumping zone, the feeding zone configured to receive the solid material located upstream, the compression zone located downstream of the feeding zone adapted to receive, heat, and compress the solidifying material into a molten condition, and the pumping zone is located downstream of the compression zone adapted to receive, move and distribute the molten plastic material in a uniform manner to the means for dispensing the molten plastic material.
